(19) United States
(12) Patent Application Publication
(10) Pub. No.: US 2016/0092412 A1
(43) Pub. Date: Mar. 31, 2016

(54) DOCUMENT PROCESSING METHOD, DOCUMENT PROCESSING APPARATUS, AND DOCUMENT PROCESSING PROGRAM

(71) Applicant: HITACHI LTD., Tokyo (JP)

(72) Inventors: Minenobu SEKI, Tokyo (JP); Yoshiyuki KOBAYASHI, Tokyo (JP)

(21) Appl. No.: 14/782,933

(22) PCT Filed: Apr. 16, 2013
(86) PCT No.: PCT/JP2013/061329

§ 371 Date: Oct. 7, 2015

(51) Int. Cl. G06F 17/22; G06K 9/00

(52) U.S. Cl. CPC G06F 17/2241; G06K 9/00449; G06K 2209/01

(57) ABSTRACT

A document processing apparatus 200 has a processor that executes programs, and a memory that stores the programs to be executed by the processor. The document processing apparatus 200 links a certain character array in a document with a character array located to a right side thereof from the certain character array or a region including the certain character array towards the right side thereof and below, and generating a network for multiple hypothetical document structures by linking the certain character array to a character array located therebelow.

### BACKGROUND OF THE INVENTION

The present invention relates to a document processing method, a document processing apparatus, and a document processing program for processing text.

In recent years, there has been a need to extract data from various non-standard documents such as work forms using a document recognition technique. Non-standard documents are documents made by various companies individually with many and various items included therein, and thus, involve more complex and various formats than non-standard forms for finance. Thus, there is a need for a method by which it is possible to extract data from documents having complex formats using easy definitions.

The document processing apparatus of JP 2006-99480 A extracts a partial image corresponding to the table region from a document image, extracts cell characteristics indicating the cell structure included in the table region, and applies a character recognition process on the partial image, thereby extracting table elements corresponding to cells. The document processing apparatus uses cell characteristics to detect simplified cells in which a plurality of cells have been consolidated to one cell, distributes the table elements of the simplified cells to other cells, and deletes the simplified cells.

JP 2008-204226 A discloses a technique of extracting data using an item name dictionary. JP 2008-33830 A discloses a technique of extracting data using a dictionary of hierarchized item names and arrangement relations.

However, documents of various and complex structures have ambiguity in terms of the interpretation of the layout structure thereof, and thus, it is difficult to define the relationship between the items and data. The technique of JP 2006-99480 A merely performs analysis using a layout structure and a predefined arrangement pattern. Thus, it is difficult to define the relationship between items and data. The technique of JP 2008-204226 A extracts data using an item name dictionary, but without using information on the hierarchical relation between item names. Thus, the layout structure of the document is limited, and it is not possible to handle various structures.

Also, in JP 2008-33830 A, in order to define various and complex structures in the document, it is necessary to predefine the arrangement relations between items, and there is a high cost in defining dictionaries for non-standard documents of many types. There is ambiguity in interpreting various and complex layout structures, and thus, these cannot be handled. Also, the cost for predefinition is high and definition is difficult without specialized knowledge, and thus, it is difficult for a general user to create definitions in order to freely obtain desired information.

### SUMMARY OF THE INVENTION

An object of the present invention is to be able to express various structures of documents at a low cost for predefinition.

An aspect of the disclosure is a document processing method executed by a computer having a processor that executes programs, and a memory that stores the programs to be executed by the processor, wherein the processor links a certain character array in a group of character arrays in a document with a character array located in a rightward direction thereof from the certain character array or a region including the certain character array towards the rightward direction and a downward direction, and links the certain character array to a character array located therebelow, thereby generating a network for multiple hypothetical document structures.

According to a representative embodiment of the present invention, it is possible to express various structures of documents at a low cost for predefinition.

### BRIEF DESCRIPTION OF THE DRAWINGS

FIG. 1 is a descriptive drawing showing a data extraction example of an embodiment of the present invention.

FIG. 2 is a block diagram for showing a hardware configuration example of the document processing apparatus.

FIG. 3 is a descriptive drawing showing one example of content stored in the dictionary DB 13 shown in FIG. 1.

FIG. 4 is a descriptive drawing showing one example of content stored in the hierarchized item name dictionary 303.

FIG. 5 is a flowchart showing an example of data extraction process steps by the document processing apparatus 200.

FIG. 6 is a descriptive drawing showing an example of a process to generate a document structure network.

FIG. 7 is a flow chart showing detailed process steps of the process to generate the network for multiple hypothetical document structures (step S504) shown in FIG. 5.

FIG. 8 is a descriptive drawing showing an example of an item/data correspondence array candidate generating process.

FIG. 9 is a descriptive drawing showing search results in the example shown in FIG. 8.

FIG. 10 is a flow chart showing an example of detailed process steps of the item/data correspondence array candidate generating process (step S505) shown in FIG. 5.

FIG. 11 is a flow chart showing an example of detailed process steps of the search process (step S1005) shown in FIG. 10.

FIG. 12 is a descriptive drawing showing a comparison example 1 between the search results and the selected hierarchized item name array.

FIG. 13 is a descriptive drawing showing a comparison example 2 between the search results and the selected hierarchized item name array.

FIG. 14 is a descriptive drawing showing a comparison example for when the non-desired item name character array is a unit character array.

FIG. 15 is a descriptive drawing showing a comparison example for when the non-desired item name character array is a unit designation character array.

FIG. 16 is a flow chart showing an example of detailed process steps of the non-desired item name character array candidate ranking process (step S506).

FIG. 17 is a descriptive drawing showing one example of extraction results 14 in step S1606 of FIG. 16.

FIG. 18 is a descriptive drawing showing a data selection display screen example 1. The data selection display screen 1800 displays the obtained document 11.

FIG. 19 is a descriptive drawing showing a data selection display screen example 2.

FIG. 20 is a block diagram showing a mechanical configuration example of the document processing apparatus 200.

FIG. 21 is a descriptive drawing showing three different types of layout analysis results for an inputted document.

FIG. 22 is a descriptive drawing showing an example of generating the document structure networks from the layout analysis results shown in FIG. 21.

FIG. 23 is a descriptive drawing showing search results.

FIG. 24 is a descriptive drawing showing an example of layout analysis results being combined.

FIG. 25 is a descriptive drawing showing generating networks using an array analysis of the frame position.

FIG. 26 is a descriptive drawing showing generating links with character arrays in a plurality of frames if the frame end position is continuous within the same frame.

FIG. 27 is a descriptive drawing showing an example of an item/data correspondence array candidate generating process.

FIG. 28 is a descriptive drawing showing the correct item/data correspondence array candidates in (a) of FIG. 27.

FIG. 29 is a descriptive drawing showing the correct item/data correspondence array candidates in (b) of FIG. 27.

FIG. 30 shows an image of results of a plurality of item/data correspondence array candidates being ranked for each entry.

### DETAILED DESCRIPTION OF THE PREFERRED EMBODIMENT

The present invention generates a network for expressing a plurality of possible document structures (hereinafter referred to as a “network for multiple hypothetical document structures”), and uses information on the contents from the network for multiple hypothetical document structures to extract data while reducing ambiguity in document structures by narrowing down the document structures.

The network for multiple hypothetical document structures is a directed graph for forming edges between nodes having a logical relationship with a character array as a node. If there is no array analysis or frame at the frame end point, then the network for multiple hypothetical document structures is generated by array analysis of the character array position. Three types of information content are used: a hierarchized item name dictionary in which the hierarchized structure and data type of the items is included, a unit character array dictionary in which a unit character array is included, and a unit designation character array dictionary including a character array that designates a unit. The data type is indicated by a symbol as being a character array, a numeral array, or a combination of a numeral and character array. The data type need not necessarily be designated.

In this manner, even a user with no specialist knowledge pertaining to document recognition techniques can define the network structure of a document. By comparing the network for multiple hypothetical document structures to content information, the document processing apparatus can narrow down a plurality of possible document structures. Thus, the document processing apparatus enables a high degree of accuracy in extracting data from various types of documents. In this manner, the document processing apparatus can extract data from non-standard documents while minimizing the number of definitions for document network structures made in advance. In particular, non-standard documents having a table format have row items and column items, and thus, the document processing apparatus can extract data at a position where the row items and column items intersect. In this manner, there is no restriction on the structure of the inputted document, and thus, the document processing apparatus increases the number of types of documents from which data can be extracted and enables a high degree of accuracy in extracting data from various documents, thereby increasing the range of document types that can be processed. Below, detailed descriptions will be made with reference to the affixed drawings.

### Data Extraction Example

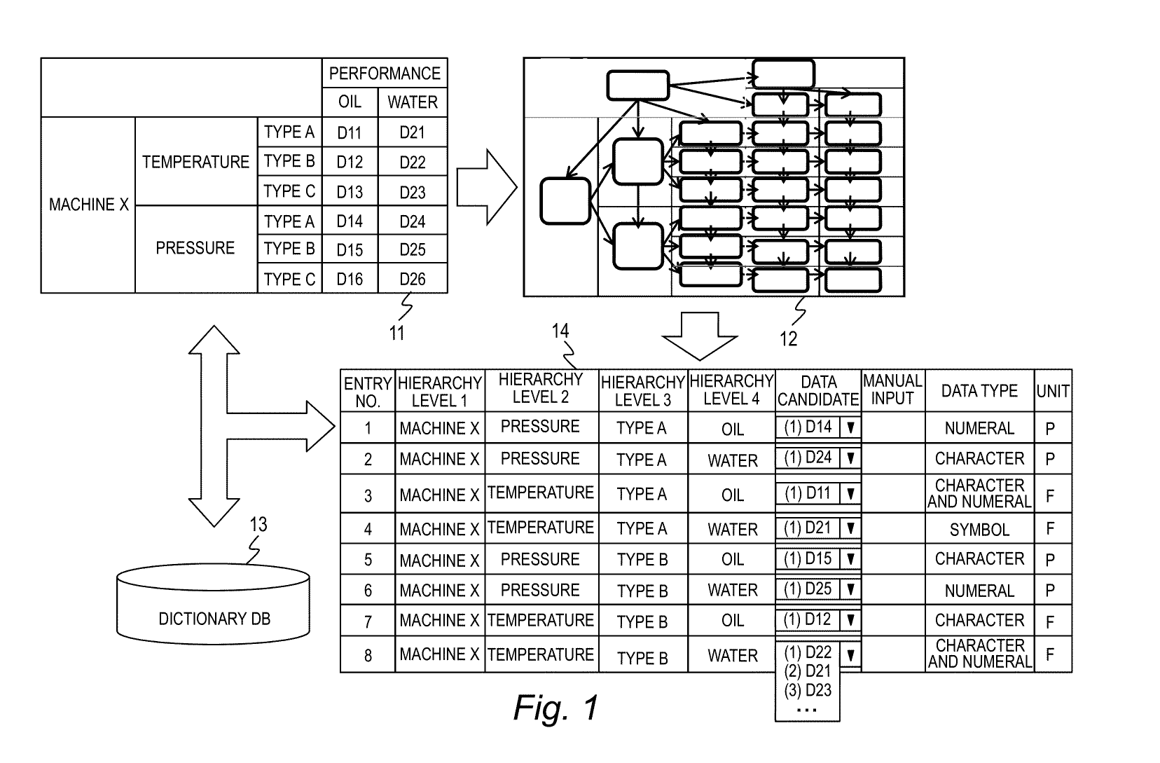

FIG. 1 is a descriptive drawing showing a data extraction example of an embodiment of the present invention. The document processing apparatus performs layout analysis of an inputted document 11. The inputted document 11 is electronic data such as image data, a spreadsheet, or a document file. If the document to be inputted is on paper, then it is converted to electronic data using a scanner. The document processing apparatus generates a network for multiple hypothetical document structures showing a hierarchized structure of character arrays in the inputted document 11 on the basis of the layout analysis results. FIG. 1 shows one network for multiple hypothetical document structures 12 being generated but a plurality thereof may be generated.

The document processing apparatus compares the character arrays in the inputted document 11 to character arrays in a dictionary DB (database) 13. The comparison is performed by using an evaluation function taking into account the length of the character array on the basis of the Levenshtein distance. Comparison can be performed even if characters in a document were found according to a character recognition process but there were errors in character recognition. The document processing apparatus obtains extraction results 14 by combining the comparison results with the document structure network 12. In the eighth entry of the extraction results 14, “D22,” “D21,” and “D23” are obtained as data candidates for “machine X,” “temperature,” “type B,” and “Water,” for example.

Also, the document processing apparatus calculates the reliability of each data candidate and ranks the data candidates according to reliability.

In the eighth entry of the extraction results 14, the data candidates are ranked according to reliability in the order of “D22,” “D21,” and “D23”. Thus, the document processing apparatus can evaluate which piece of data is appropriate for each entry in the extraction results 14 by generating the document structure network 12 even without defining a document structure network corresponding to the inputted document 11.

<Hardware Configuration Example of Document Processing Apparatus>

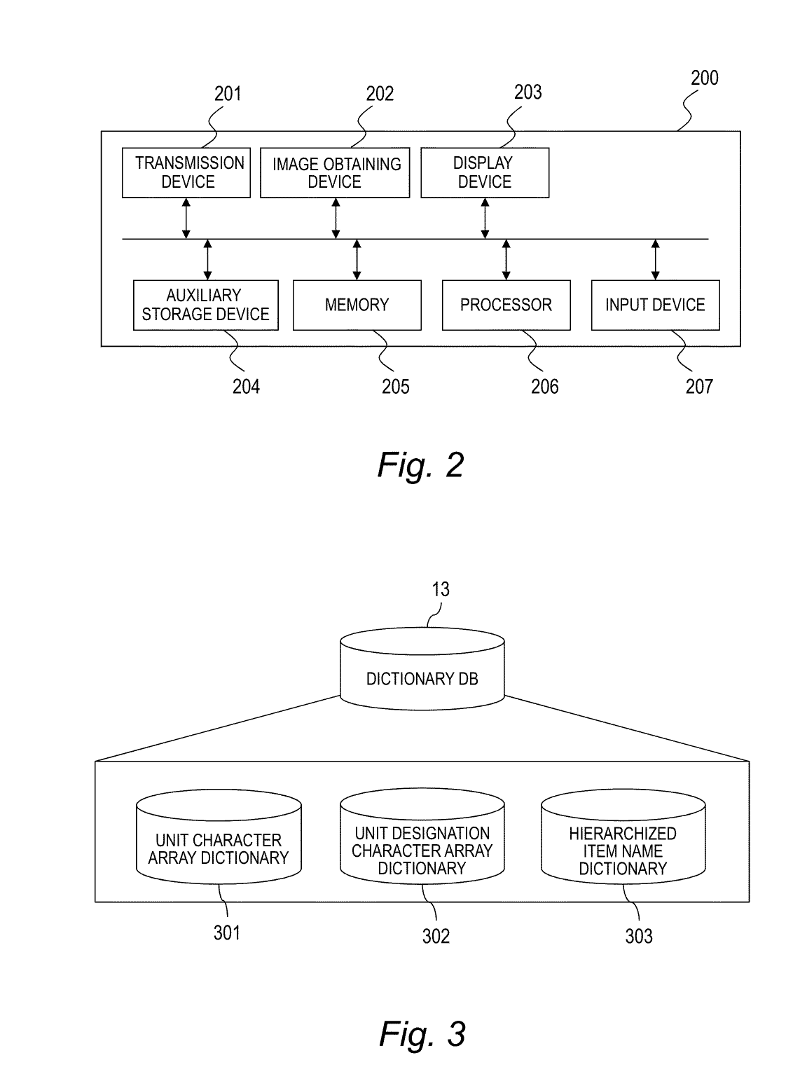

FIG. 2 is a block diagram for showing a hardware configuration example of the document processing apparatus. A document processing apparatus 200 has a transmission device 201, an image acquisition device 202, a display device 203, an auxiliary storage device 204, memory 205, a processor 206, and an input device 207, and these device are connected via a transmission line such as a PCI bus.

The transmission device 201 is a network interface for connecting the document processing apparatus 200 to a network. The image acquisition device 202 is a device for acquiring document images from which data is to be extracted, and examples thereof include scanners, decoders, OCR devices, digital cameras, and the like. The image acquisition device 202 may be an interface into which image data for documents obtained by an externally connected scanner is inputted.

The display device 203 is a display for displaying program execution results, and an example thereof is a liquid crystal display device. The auxiliary storage device 204 is a non-volatile storage device such as a magnetic disk drive or flash memory (SSD), and stores programs to be executed by the processor 206 and data to be used while executing the programs. The memory 205 is a high speed and volatile storage device such as DRAM (dynamic random access memory), and stores the operating system and application programs.

The processor 206 is a central processing unit that executes programs stored in the memory 205. As a result of the processor 206 executing the operating system, basic functions of the document processing apparatus 200 are realized, and by executing application programs, functions provided by the document processing apparatus 200 are realized. The input device 207 is a user interface such as a keyboard and mouse.

Programs executed by the processor 206 are provided to the computer through a non-volatile storage medium or a network, and stored in the auxiliary storage device 204, which is a non-transitory storage medium. In other words, the programs to be executed by the processor 206 are read from the auxiliary storage device 204, loaded into the memory 205, and executed by the processor 206. Documents inputted to the CPU 206 may be inputted from the image acquisition device 202 or the transmission device 201, or stored in the auxiliary storage device 204. A representative example is a personal computer to which a display and a decoder are connected.

The document processing apparatus 200 outputs the extraction results 14 from the data extraction process to the display device 203. The document processing apparatus 200 may output the extraction results 14 from the data extraction process to an external point through the transmission device 201, or the extraction results 14 may be used by another program executed by the document processing apparatus 200.

<Stored Content of Dictionary DB 13>

FIG. 3 is a descriptive drawing showing one example of content stored in the dictionary DB 13 shown in FIG. 1. The dictionary DB 13 is a database stored in the memory 205 or the auxiliary storage device 206 shown in FIG. 2. The document processing apparatus 200 may be configured so as to be able to refer to a dictionary DB 13 stored on an external server through the transmission device 201. The dictionary DB 13 has a unit character array dictionary 301, a unit designation character array dictionary 302, and a hierarchized item name dictionary 303.

The unit character array dictionary 301 is dictionary data storing unit character arrays. The unit character array is a character array indicating a unit such as “kg” or “cm.” In this manner, it is possible to decrease the possibility that the unit character array would be extracted as data.

The unit designation character array dictionary 302 is dictionary data storing unit designation character arrays. The unit designation character array is a character array designating the unit. The unit designation character array dictionary 302 stores a character array such as “UNIT” as a unit designation character array, for example. There is a possibility that the non-desired item name character array indicated by the unit designation character array is a unit character array. By using the unit designation character array dictionary 302, it is possible to determine whether or not the non-desired item name character array might indicate a unit. Thus, it is possible to decrease the possibility that the unit character array would be extracted as data.

The hierarchized item name dictionary 303 is a dictionary that stores hierarchized item name arrays. The hierarchized item name array is data combining item names assigned a hierarchy to data types. Hierarchy is information indicating level relations among item names. In this example, smaller hierarchy numbers indicate a higher hierarchy. Item names are character arrays that can be items. The collection of hierarchy level 1 to hierarchy level 4 in the entries e1 to e8 in the extraction results 14 and character arrays indicating the data types and units in FIG. 1 is the hierarchized item name array. By using the hierarchized item name dictionary 303, it is possible to rank data candidates obtainable for each hierarchized item name array without predefining the network for multiple hypothetical document structures 12 of the document 11.

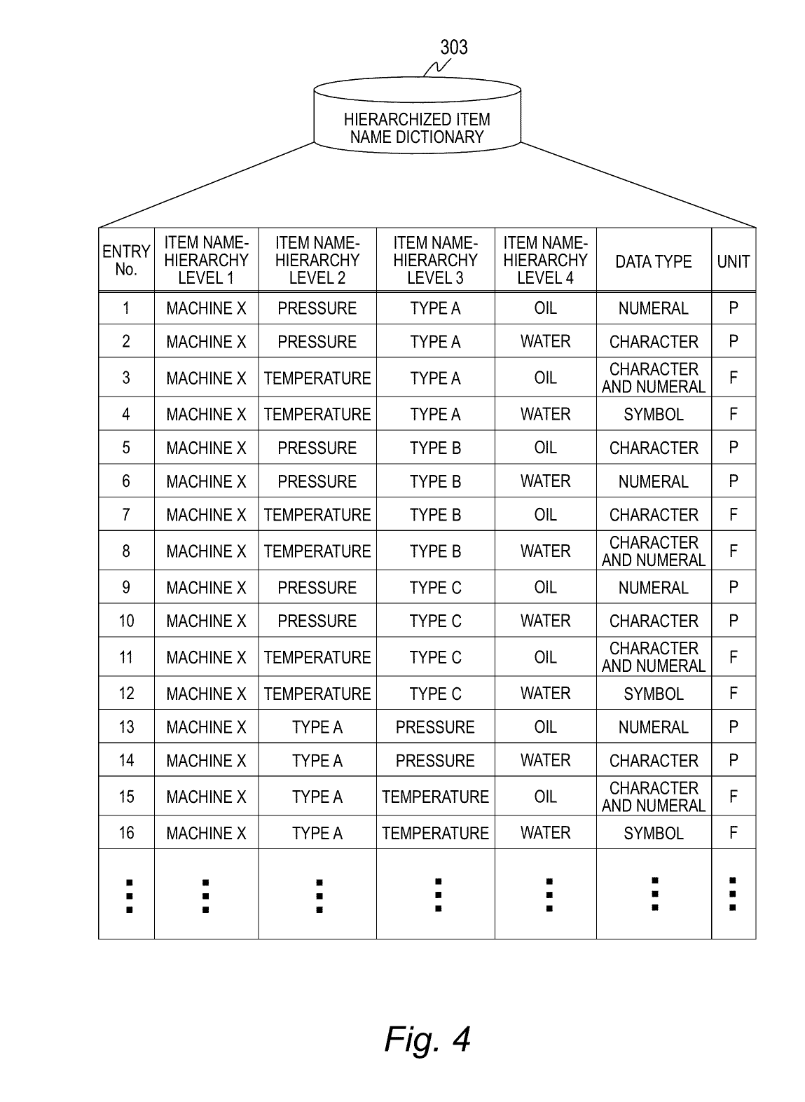

FIG. 4 is a descriptive drawing showing one example of content stored in the hierarchized item name dictionary 303. The hierarchized item name dictionary 303 has entry number items on the left, item names, data types, and units, and there is an entry for each entry number. The entry number is identifying information uniquely defining the hierarchized item name array. Below, the entries in the entry number # (# being an integer of 1 or greater) will be indicated as “entry e#.”

The hierarchy items store item names for each hierarchical level. For example, in entry e1, the hierarchy items are stored as follows: “machine X” as the item name for hierarchy level 1, “pressure” as the item name for hierarchy level 2, “type A” as the item name for hierarchy level 3, and “Oil” as the item name for hierarchy level 4.

The data type stores information indicating the type of data corresponding to the hierarchized item name array. The data type includes numeral, character, symbol, or character and numeral, for example. The unit item stores the unit of the data corresponding to the hierarchized item name array. The unit item stores a character array indicating the unit. For example, in entry 1, “P” is stored as the character array indicating the unit.

<Data Extraction Process Steps>

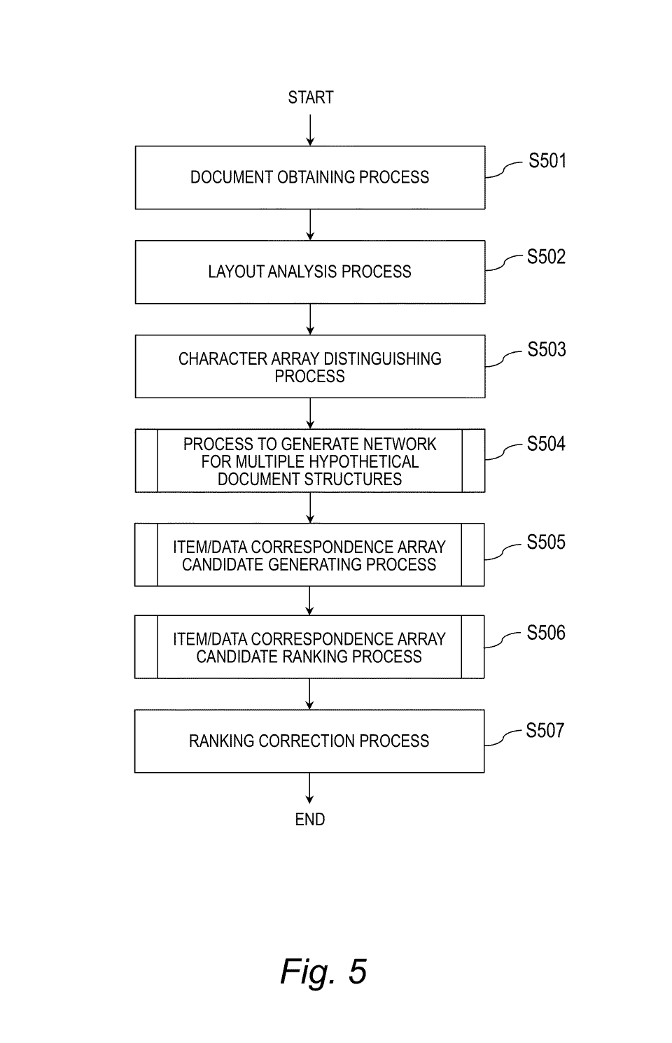

FIG. 5 is a flowchart showing an example of data extraction process steps by the document processing apparatus 200. First, the document processing apparatus 200 executes a document acquisition process (step S501). Specifically, the document processing apparatus 200 reads from the auxiliary storage device 206 an electronic document such as image data, a spread sheet, or a document file or receives such an electronic document through the transmission device 201, for example. The document processing apparatus 200 may convert a paper document to image data by scanning using the image acquisition device 202. The document processing apparatus 200 may obtain text data by performing optical character recognition (OCR) on the document 11 converted to image data.

Next, the document processing apparatus 200 executes a layout analysis process (step S502). In the layout analysis process (step S502), the document processing apparatus 200 analyzes the layout of the document 11 obtained in step S501. The document processing apparatus 200 extracts the frame and the character row using position information of the character and position information of ruled lines. In this manner, the layout of the obtained document 11 is determined.

Next, the document processing apparatus 200 executes a character array distinguishing process (step S503). In the character array distinguishing process (step S503), the document processing apparatus 200 distinguishes attributes to determine what the character array indicates. Specifically, it performs four distinguishing processes: (1) whether the item name is in the hierarchized item name dictionary (item name/character array comparison), (2) what the data type is (data character array type determination), (3) whether the character array is a unit character array (unit character array comparison), and (4) whether the character array is a unit designation character array (unit designation character array comparison).

(1) In the item name character array comparison process, the document processing apparatus 200 determines whether the character array in the character row matches the item name in the hierarchized item name dictionary. Matching character arrays are designated as “desired item character arrays” and non-matching character arrays are designated as “non-desired item character arrays.” The non-desired item character arrays include character arrays indicating the item names and character arrays indicating data, which are not in the hierarchized item name dictionary, and no distinction is made therebetween.

(2) In the data character array type determination process, the document processing apparatus 200 determines whether the character array is a numeral array that only includes numerals, whether the character array is a non-numeral character array that includes characters other than numerals, or whether the character array is a numeral/character array including both characters and numerals.

(3) In the unit character array comparison process, the document processing apparatus 200 determines whether the character array in each character row matches the character array indicated in the unit character array dictionary.

(4) In the unit designation character array comparison process, the document processing apparatus 200 determines whether the character array in each character row matches the character array indicated in the unit designation character array dictionary. In order to determine whether or not the character array matches an item name, unit character array, or unit designation character array, it is possible to use an evaluation function taking into account the length of the character array on the basis of the Levenshtein distance, but another method may be used.

Next, the document processing apparatus 200 executes a process to generate a network for multiple hypothetical document structures (step S504). In the process to generate a network for multiple hypothetical document structures (step S504), the document processing apparatus 200 generates the document structure network 12 from the obtained document. Specifically, the document processing apparatus 200 generates the network for multiple hypothetical document structures expressing a plurality of document structure possibilities from the layout obtained in the layout analysis process (step S502).

Next, the document processing apparatus 200 executes an item/data correspondence array candidate generating process (step S505). In the item/data correspondence array candidate generating process (step S505), the document processing apparatus 200 extracts from the network for multiple hypothetical document structures a character array group of item names and data corresponding to each entry in the hierarchized item name dictionary (item/data correspondence array), and a group of unit designation character arrays and unit character arrays (unit character array correspondence array). There is a possibility that there are a plurality of relationships between the item name and data character array corresponding to each entry. Thus, candidates for association between a plurality of possible items and data (item/data correspondence array) are extracted. These are referred to as item/data correspondence candidates. Details will be described later.

Next, the document processing apparatus 200 executes an item/data correspondence array candidate ranking process (step S506). In the item/data correspondence array candidate ranking process (step S506), the degree of reliability is calculated in which it is determined to what degree the item/data correspondence array candidate matches each entry of the hierarchized item name dictionary, and ranking is performed using an item/data correspondence score.

Next, the document processing apparatus 200 executes a ranking correction process (step S507). In the ranking correction process (step S507), results of ranking according to the degree of reliability are corrected. The ranking is corrected according to a character array compared to a unit character array and a character array compared to a unit designation character array. By this process, even if a unit character array is between an item and a piece of data, it is possible to output a desired piece of data at a high order instead of the unit character array. The ranked item/data correspondence arrays are listed in a pull-down menu as shown in FIG. 1.

In this manner, the document processing apparatus 200 can extract data at high accuracy even from a document having a plurality of item names with the items pointing to data having a hierarchical structure, or a document with complex and various structures such as character arrays indicating units being included between items and data, and no frame borders being present. Also, the document processing apparatus 200 can extract data corresponding to a specification item having a hierarchical structure merely by designating a hierarchized item data dictionary. Thus, even a user with no specialist knowledge pertaining to document recognition techniques can define and use a dictionary.

<Example of Process to Generate Network for Multiple Hypothetical Document Structures>

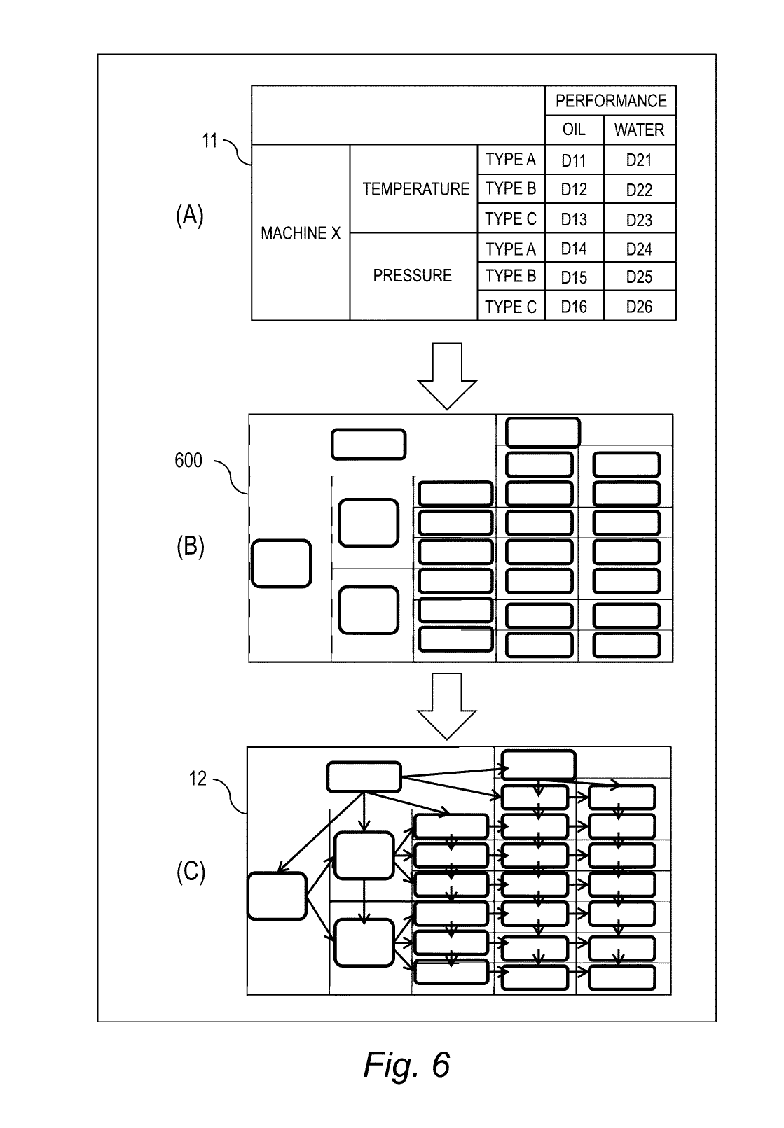

FIG. 6 is a descriptive drawing showing an example of a process to generate a document structure network. In FIG. 6, (A) is an example of a document 11 obtained by the document acquisition process (step S501). (B) is analysis results 600 of a layout analysis process (step S502), which is the next stage after (A). In (B), the frame of the document 11 is recognized. Also, in (B), character array regions in the document indicated in bold line rectangles are also recognized. Thereafter, the bold line rectangles become the nodes of the document structure network 12. The bold line rectangles are hereinafter referred to as “nodes.” Each node is associated with the character array from which it is generated.

(C) is the generation results of the document structure network generating process (step S504), which is the next stage after (B). The generation results become the network for multiple hypothetical document structures 12. The network for multiple hypothetical document structures 12 is a directed graph in which the nodes are connected by links.

The network for multiple hypothetical document structures is generated using the following two characteristics. The first characteristic is that the logical relationships between character arrays in the document are indicated such that meanings are connected from left to right and up to down. The second characteristic is that there are logical relationships between character arrays in frames for which the frame end positions are filled.

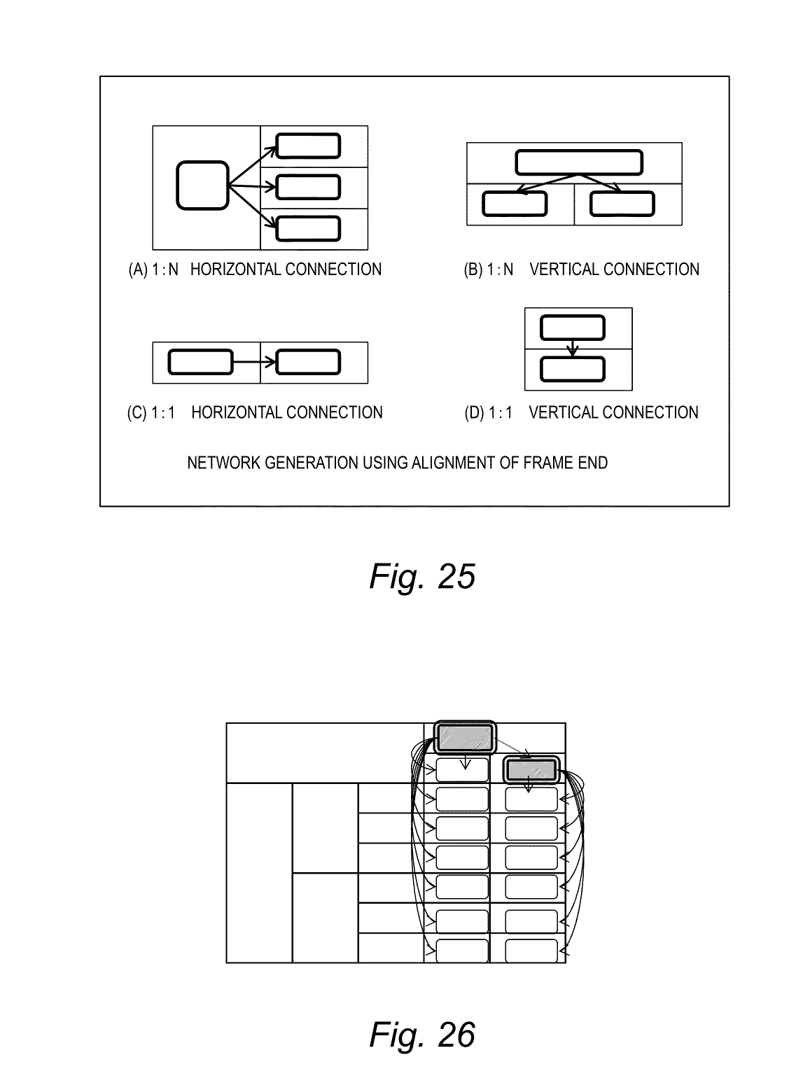

If, as shown in (a) and (b) of FIG. 25, the frame end positions are filled according to the relation of 1:N (N being an integer greater than 1), in many cases this means that character rows in the frame have a meaningful hierarchical relationship of item name and data or item name and item name. Also, if, as shown in (c) and (d) of FIG. 25, the frame end positions are filled according to the relation of 1:1, in many cases this means that character rows in the frame have a relationship of item name and data or consecutive pieces of data. The character arrays in the document are indicated such that the hierarchical relationship between item and data, and item is indicated from left to right and up to down. Thus, the document processing apparatus 200 generates links connected nodes from left to right and up to down.

Similar to the cases of (a) and (b), the character arrays in the document are indicated so as to have a relationship in the order of item and data, and data from left to right and up to down, and thus, the document processing apparatus 200 generates links from left to right and up to down. Also, there is a correspondence to the recording of continuous data downward or to the right from the item position, and thus, the document processing apparatus 200, as shown in FIG. 26, generates links with character arrays in a plurality of frames if the frame end position is continuous within the same frame. Only links from the two character arrays indicated with shading are shown. Links are similarly generated from up to down and left to right from other character arrays as well.

If referring to a node in the row direction from right to left, then each node in the group of nodes is linked to a node in a frame that is adjacent and to the left of the frame including the original node. Also, if referring to a node in the column direction from down to up, then each node is linked to a node in a frame directly above the frame including the original node.

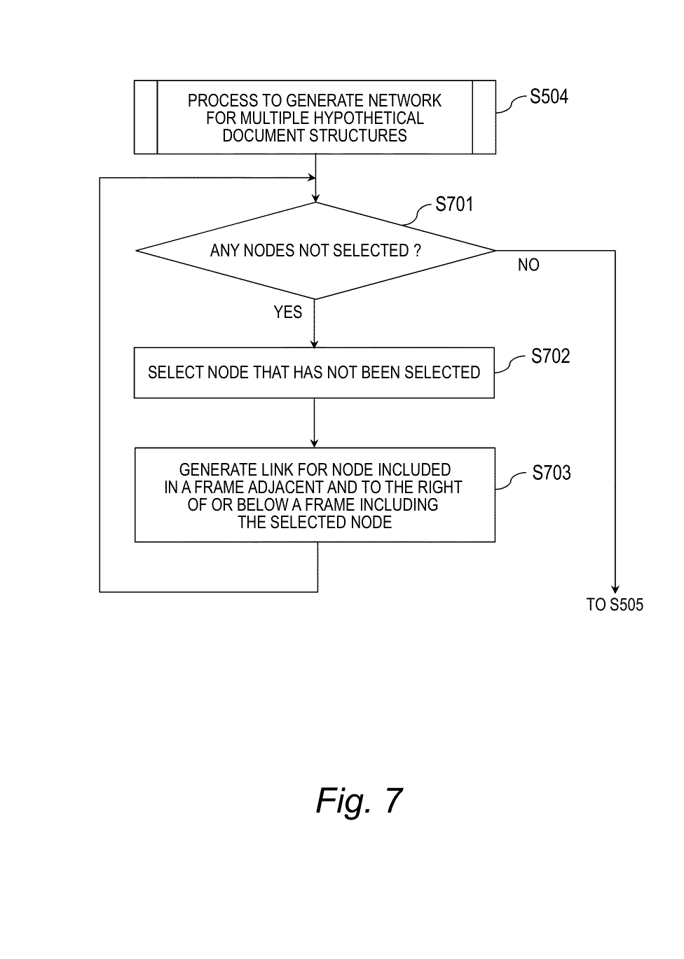

FIG. 7 is a flow chart showing detailed process steps of the process to generate the network for multiple hypothetical document structures (step S504) shown in FIG. 5. First, the document processing apparatus 200 determines whether or not there are non-selected nodes within the group of nodes in the analysis results shown in (B) of FIG. 6 (step S701). If there are non-selected nodes (step S702:Yes), then the document processing apparatus 200 selects one non-selected node (step S702). Then, the document processing apparatus 200 generates a link to a node included in each frame adjacent and to the right, and directly below the frame including the selected node (step S703). Then, the process returns to step S701.

In step S701, if there are no non-selected nodes remaining (step S701:No), then the process moves on to an item/data correspondence array candidate generating process (step S505). In this manner, the series of processes of the network for multiple hypothetical document structures process (step S504) is ended. By the network for multiple hypothetical document structures process (step S504), even if the network structure of the document is not defined in advance, the structure of the obtained document can be specified as the document structure network 12.

<Example of Item/Data Correspondence Array Candidates Generating Process>

In the item/data correspondence array candidate generating process, a plurality of item/data correspondence array candidates are generated from the network for multiple hypothetical document structures.

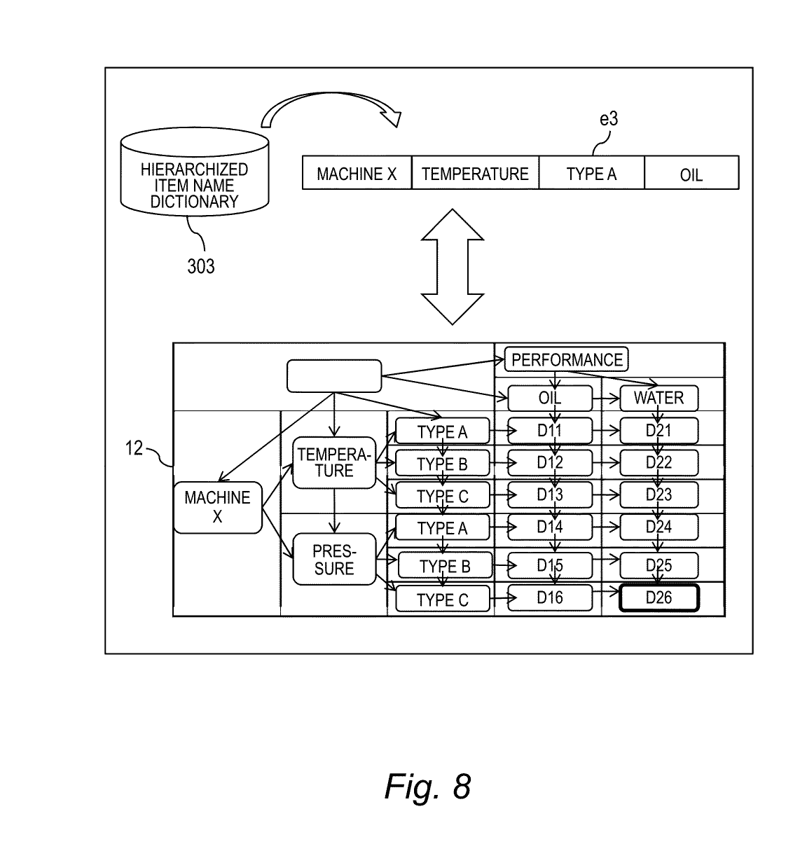

FIG. 8 is a descriptive drawing showing an example of an item/data correspondence array candidate generating process. The document processing apparatus 200 performs a search process started at all non-desired item character arrays for all entries in the hierarchized item name dictionary. In FIG. 8, the document processing apparatus 200 selects a certain hierarchized item name array from the hierarchized item name dictionary 303. In this example, the hierarchized item name array of entry e3 is selected. Also, the document processing apparatus 200 selects a node corresponding to the non-desired item name character array of the document structure network 12. Here, a node corresponding to the non-desired item name character array “D26” is selected. In the item/data correspondence array generating process (step S505), a node corresponding to the selected non-desired item name character array is designated as the node to focus on, and the document structure network 12 is searched for nodes corresponding to desired item name character arrays to the left and above the selected character array.

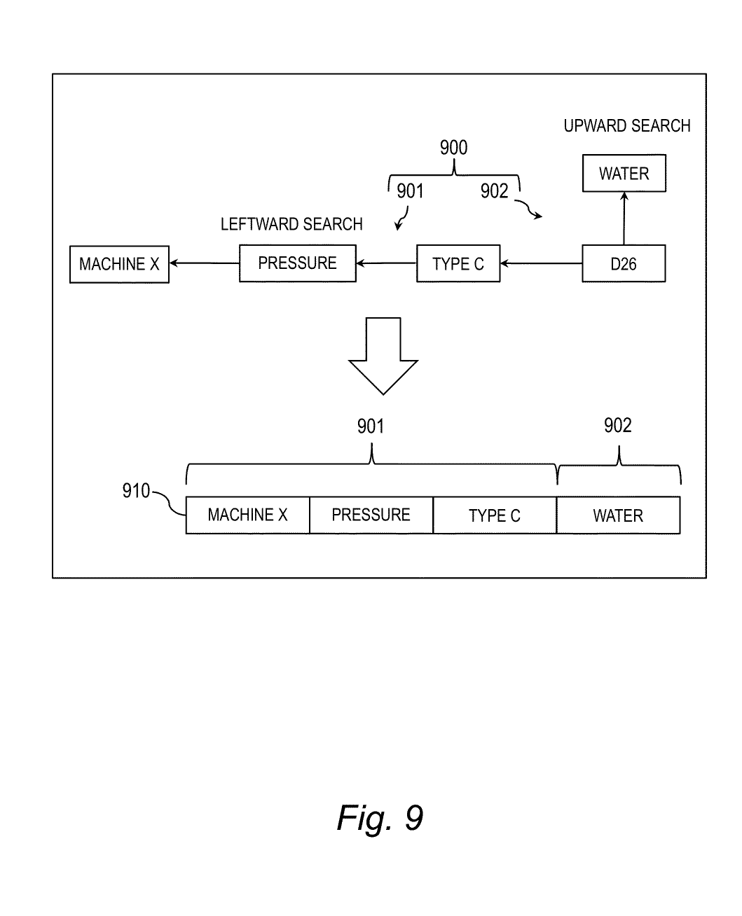

FIG. 9 is a descriptive drawing showing search results in the example shown in FIG. 8. In the search process, the document processing apparatus 200 searches for the item name character array linked to the non-desired item name character array under the assumption that the non-desired item name character array designated as the starting point is data. The document processing apparatus 200 first searches for a desired item name character array appearing to the left. The document processing apparatus 200 then searches for a desired item name character array appearing thereabove. The document processing apparatus 200 links the leftward direction search results and the upper direction search results obtained thereby, to attain the item/data correspondence array candidate.

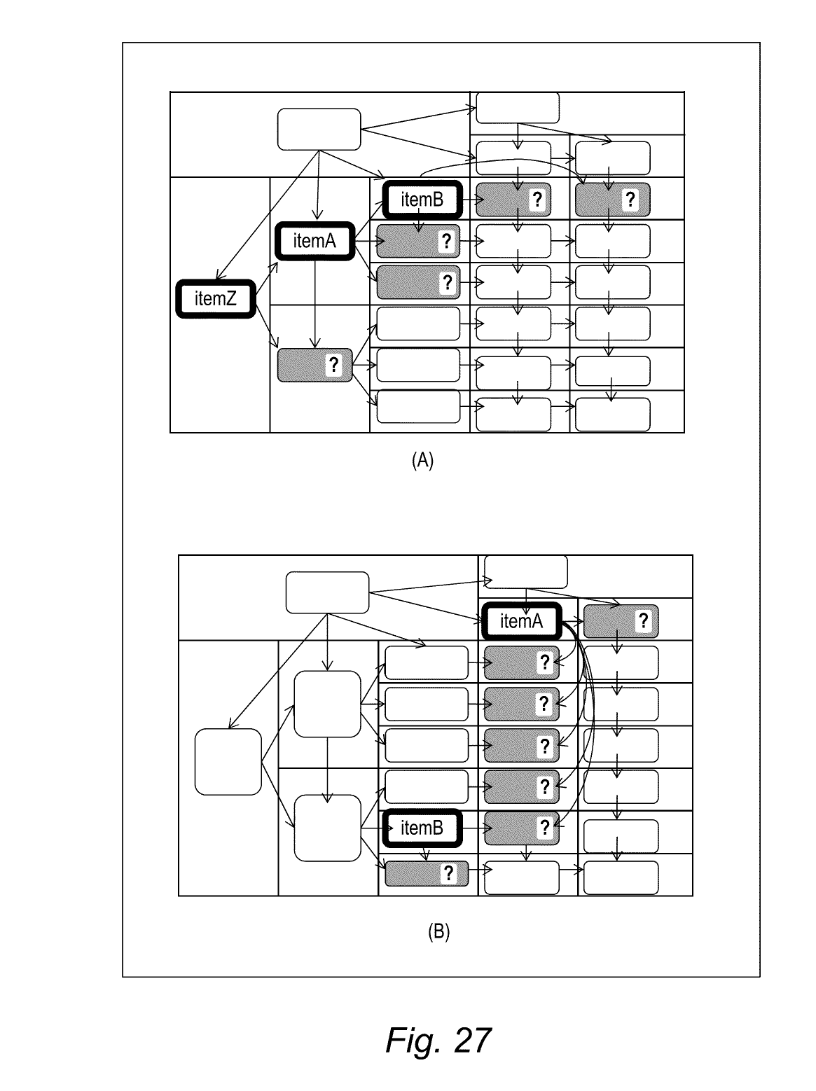

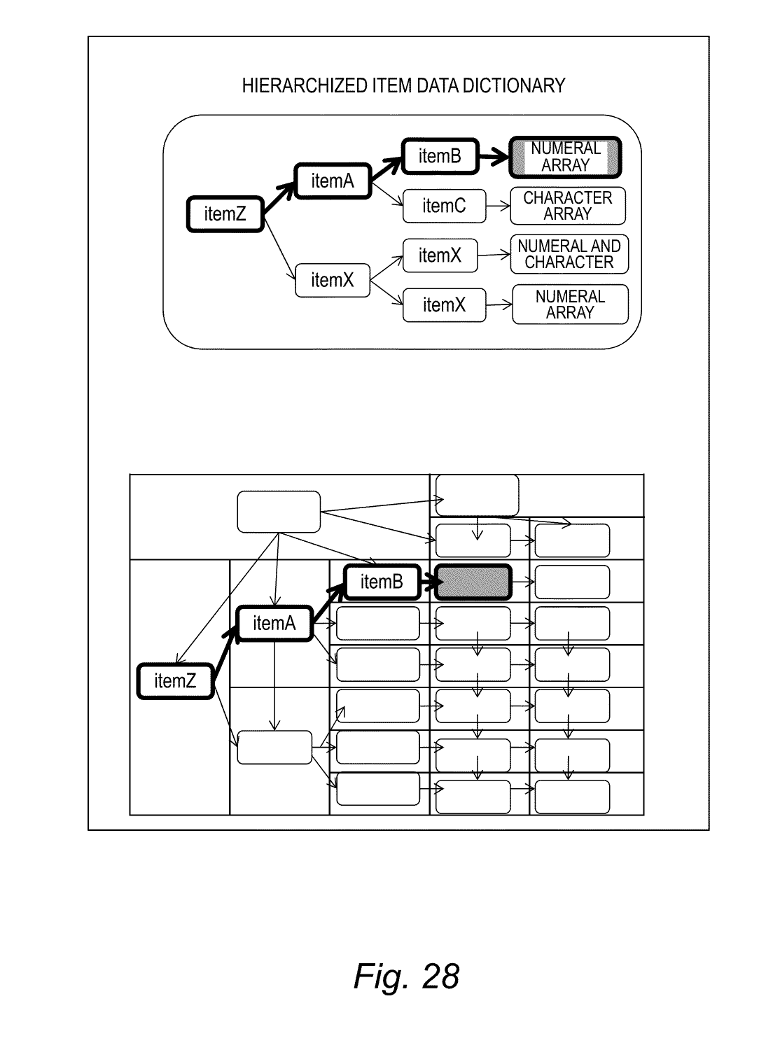

The shaded character arrays shown in (a) of FIG. 27 are non-desired item character arrays to be candidates if itemZ, itemA, and itemB are referenced as item names. FIG. 28 shows the correct item/data correspondence array candidates. The three item names for entries being focused on among the hierarchized item name dictionary are the non-desired item character arrays with matching item names.

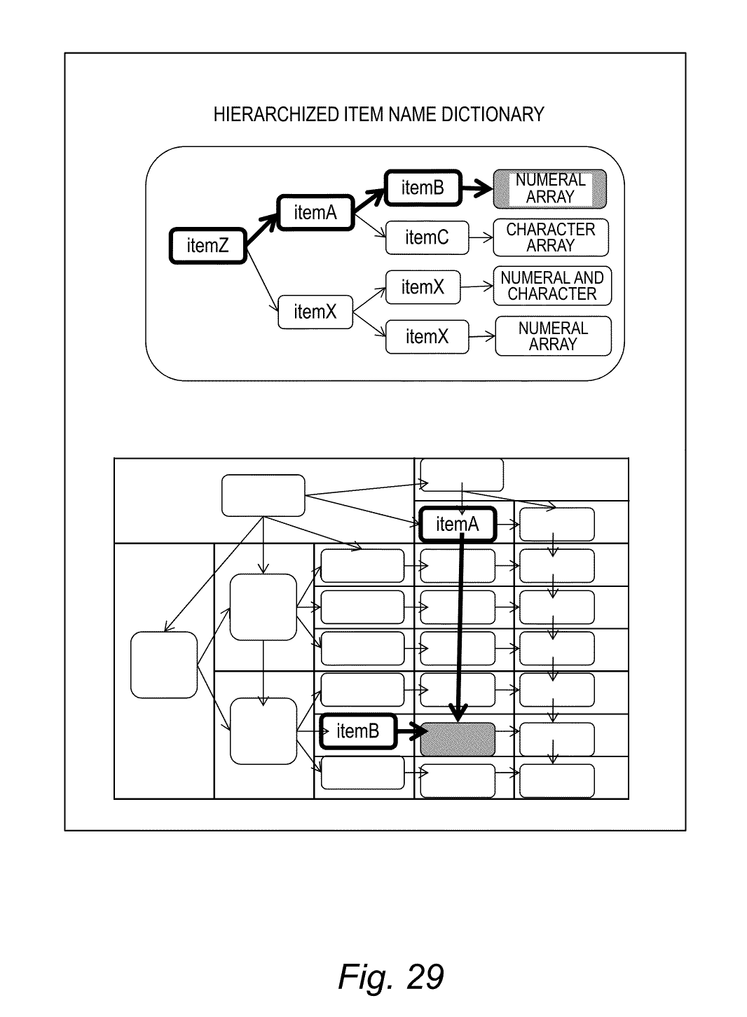

(b) of FIG. 27 is a chart having a different arrangement of character arrays than (a) of FIG. 27. The shaded character arrays are non-desired item character arrays to be candidates if itemA and itemB are referenced as item names. FIG. 29 shows the correct item/data correspondence array candidates. By linking the leftward direction search results with the upper direction search results, the document processing apparatus 200 extracts the non-desired item character array indicated by two-dimensional item names.

The process of searching for desired item name character arrays under the assumption that the non-desired item character arrays are data has been described. Similarly, the document processing apparatus 200 extracts a unit character array correspondence array by searching for unit character arrays under the assumption that the non-desired item character arrays are unit character arrays.

The search results 900 include leftward direction search results 901 and upper direction search results 902. Non-desired item name character arrays other than the original node are not included in the search results 900. Also, in the search results 900, the desired item name character arrays directly indicating the non-desired item name character arrays are the desired item name character array in the bottommost layer of the leftward direction search results 901 and the desired item name character array in the bottommost layer of the upper direction search results 902. In the example of FIG. 9, these are the desired item name character array “type C” and the desired item name character array “Water.” The document processing apparatus 200 links the leftward direction search results 901 to the upper direction search results 902, and generates the item/data correspondence array 910.

The reason for performing a search in this manner is because the row direction (horizontal direction) in the table is seen from left to right, and the column direction (vertical direction) is seen from up to down. If performing a search from right to left in the row direction, the document processing apparatus 200 searches to the right of the node to be focused on. If performing a search from down to up in the column direction, the document processing apparatus 200 searches below the node to be focused on.

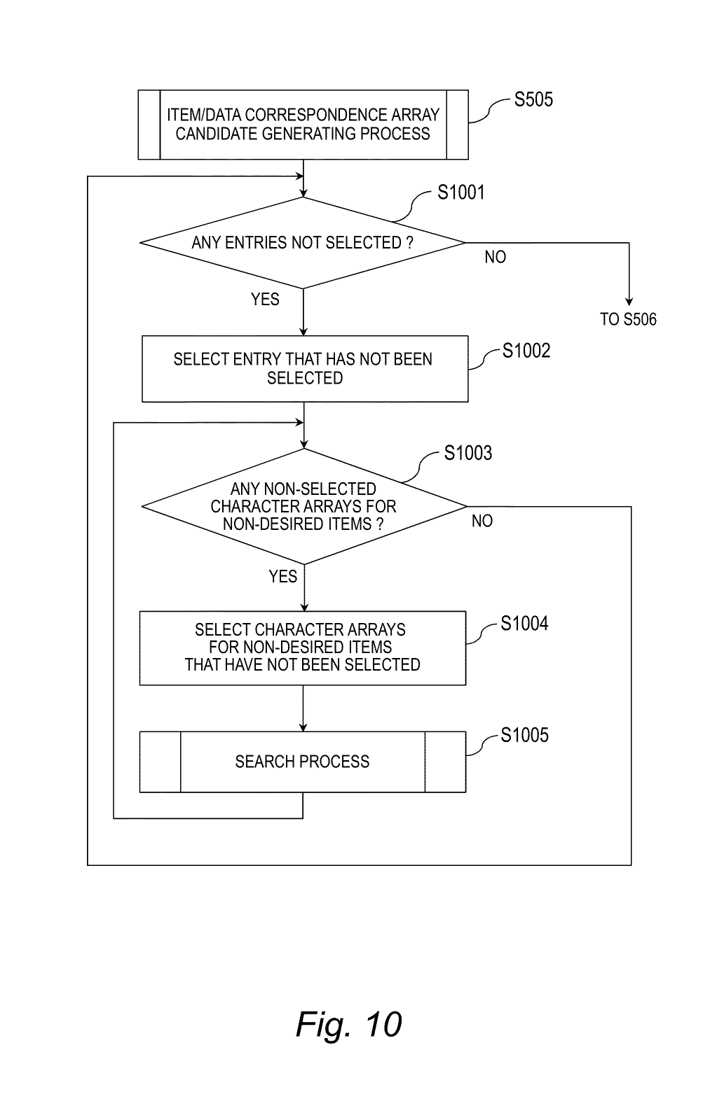

FIG. 10 is a flow chart showing an example of detailed process steps of the item/data correspondence array candidate generating process (step S505) shown in FIG. 5. First, the document processing apparatus 200 determines whether or not there are any non-selected entries in the hierarchized item name dictionary 303 (step S1001). If there are non-selected entries (step S1001:Yes), then the document processing apparatus 200 selects one non-selected entry (step S1002).

Also, the document processing apparatus 200 determines whether or not there are non-desired item name character arrays that have not been selected in the selected entry (step S1003). If there are non-desired item name character arrays that have not been selected (step S1003:Yes), then the document processing apparatus 200 selects one non-selected non-desired item name character array (step S1004).

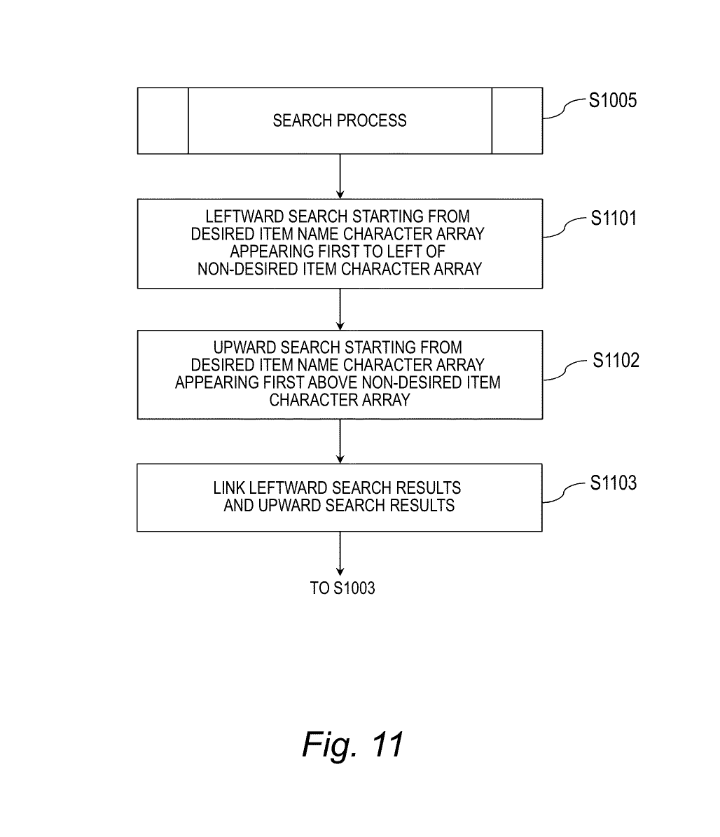

The document processing apparatus 200 executes a search process for the selected non-desired item name character array (step S1005). Details of the search process (step S1005) are shown in FIG. 11. By executing the search process (step S1005), the search results as shown in FIG. 10 are generated as item/data array candidates. After the search process (step S1005), the process returns to step S1003. In step S1003, if there are no non-desired item name character arrays that have not been selected (step S1003:No), then the process returns to step S1001. In step S1001, if there are no non-selected entries remaining (step S1001:No), then the process moves on to a non-desired item name character array ranking process (step S506).

FIG. 11 is a flow chart showing an example of detailed process steps of the search process (step S1005) shown in FIG. 10. First, the document processing apparatus 200 searches for a desired item name character array leftward from the first desired item name character array appearing to the left of the selected non-desired item name character array (step S1101). Once there are no more desired item name character arrays to the left, the search ends. Also, the document processing apparatus 200 searches for a desired item name character array upward from the first desired item name character array appearing above the selected non-desired item name character array (step S1102). Once there are no more desired item name character arrays above, the search ends. Steps 1101 and 1102 may be executed in this order, in the opposite order, or simultaneously. Then, the document processing apparatus 200 links the leftward direction search results 901 of step S1101 to the upper direction search results 902 of step S1102 (step S1103). In this manner, it is possible to attain the item/data correspondence array 910 shown in FIG. 9.

<Example of Item/Data Correspondence Array Candidate Ranking Process>

Next, an example of an item/data correspondence array candidate ranking process will be described. In the item/data correspondence array candidate ranking process (step S507), the document processing apparatus 200 calculates the degree of reliability in which it is determined to what degree the item/data correspondence array candidate matches each entry of the hierarchized item name dictionary, and ranks the item/data correspondence array candidates.

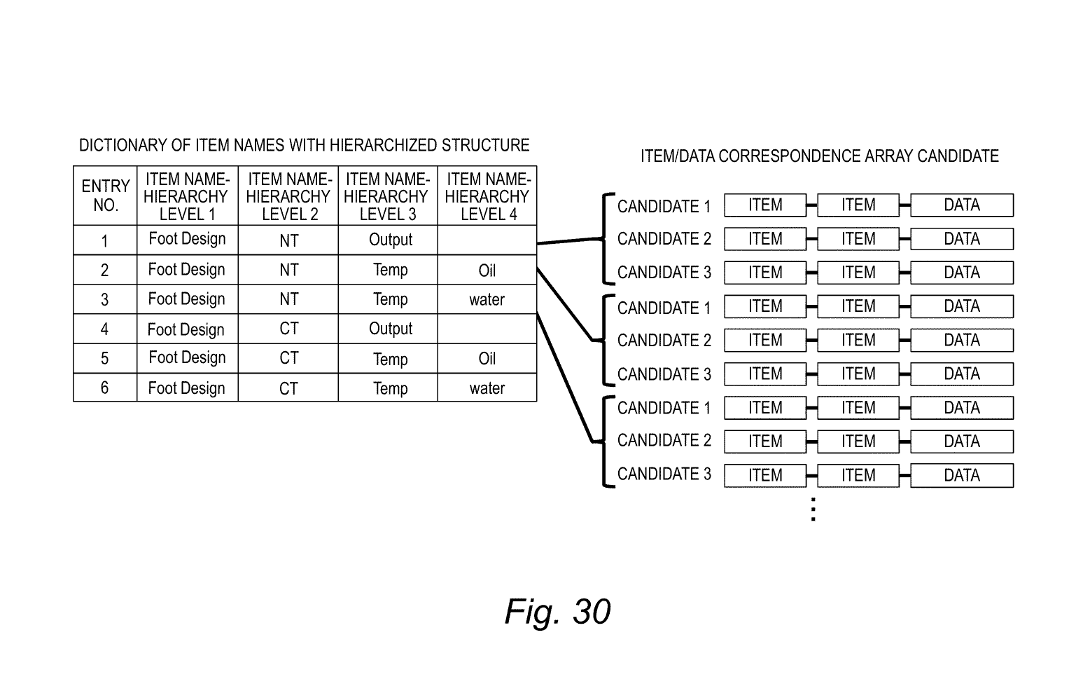

FIG. 30 shows an image of results of a plurality of item/data correspondence array candidates being ranked for each entry. The degree of reliability is the weighted linear sum of the next five values.

(1) Matching value of item names: the number of item names among the item/data correspondence array candidates that match the item names in the entry being focused on.

(2) Non-matching value of item names: the number of item names among the item/data correspondence array candidates that do not match the item names in the entry being focused on and instead match other entries.

(3) Item name comparison: the degree to which the item names match; a value taking into consideration the length of the character array according to the Levenshtein distance.

(4) Item name order: the degree to which the order of appearance of the item name in the entry being focused on matches the order of appearance of the item name in the item/data correspondence array candidate.

(5) Data matching degree: whether the data type in the item/data correspondence array candidate matches the data type in the entry being focused on.

In addition, the document processing apparatus 200 prioritizes the candidate, among the item/data correspondence array candidates, for which the item name directly connected to data matches the item name in the bottommost layer of each entry, and assigns this candidate a higher ranking. This is because, among the item names recorded in each entry, the higher order item names are often terms modifying the lower order item names, and the item names in bottommost layer are often terms directly pointing to data.

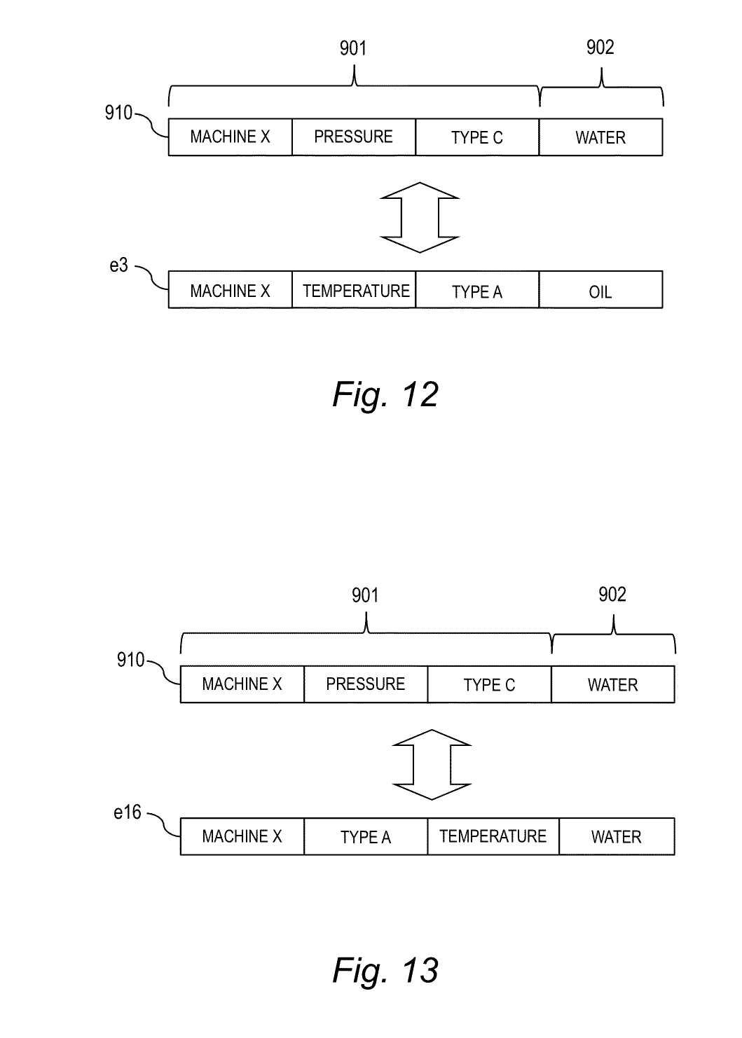

FIG. 12 is a descriptive drawing showing a comparison example 1 between the search results and the selected hierarchized item name array. Here, an example is given in which the item/data correspondence array 910 obtained from the search results 900 shown in FIG. 9 is compared to the hierarchized item name array of the entry e3 selected in FIG. 8. The item/data correspondence array 910 is formed by linking the leftward direction search results 901 and the upper direction search results 902.

In this example, the edit distance (Levenshtein distance) between character arrays and the degree to which the numbers of items match are used. The number of desired item name character arrays matching the item/data correspondence array 910 obtained from the hierarchized item name array and search results 900 by similar character array comparison is designated as “t.”

The “i”-th desired item name character array among the desired item name character arrays matching the item/data correspondence array 910 obtained from the search results 900 by similar character array comparison is designated as “Wi,” and the number of characters in Wi is designated as “Mi.” The edit distance (Levenshtein distance) for when Wi is compared to the hierarchized item name array is designated as “Ni.” In such a case, the degree of reliability F can be represented in formula (1). α is a weighting parameter that can be adjusted by the user.

$$F = t - α {\sum }_{i = 0}^{t} ( \frac{Ni}{Mi} ) \qquad ( 1 )$$

The degree of reliability F of formula (1) is greater, the larger the number of matching desired item name character arrays as determined by the similarity character array comparison is, and the degree of reliability F is less, the larger the edit distance used during such comparison is. Thus, the degree of reliability F indicates the certainty that the item/data correspondence array obtained in the search results corresponds to the hierarchized item name array. Also, the degree of reliability F is a greater value, the larger the number of matching desired item name character arrays is, and in the case of a function in which the value is greater the higher the degree of similarity is (a value that is lower, the greater the edit distance is), then another function or conversion table may be used.

In the example of FIG. 12, “machine X” is in common in the first hierarchy level, but the desired item name character arrays in the second to fourth hierarchy levels do not match. Thus, t=1. Therefore, i=1, and the desired item name character array Wi is the character array “machine X.”

A function, having as arguments the number of desired item name character arrays t matching according to similarity character array comparison, Mi, and the edit distance Ni, was used to calculate the degree of reliability, but not all of these necessarily need to be used. Also, the degree of similarity between items was calculated using the edit distance Ni, but as long as the degree of similarity between items is used, the degree of reliability may be calculated using a value other than the edit distance.

FIG. 13 is a descriptive drawing showing a comparison example 2 between the search results and the selected hierarchized item name array. A comparison example is shown comparing the item/data correspondence array 910 obtained from the search results 900 for the non-desired item name character array “D22” and the hierarchized item name array of the entry e16 in FIG. 4. In the case of FIG. 13, the number of matching character arrays t=3. Thus, W1=“machine X,” W2=“temperature,” and W3=“Water.”

As shown in FIG. 13, the position of “temperature” in the array differs between the hierarchized item name array and the item/data correspondence array 910. The degree to which these arrays matched may also be added to the formula (1) as the weighted linear sum. The degree of reliability changes according to the difference between the arrays, and thus, the more similar the arrays are, the higher the degree of reliability F is. This improves the accuracy of data extraction. Also, even if there are differences between the arrays, the candidate remains despite the degree of reliability F decreasing, and thus, various types of documents can be handled.

Also, the document processing apparatus 200 may add the degree to which the desired item name character array directly indicating the non-desired item name character array matches to formula (1) as an item of the weighted linear sum. In the example of FIG. 12, the non-desired item name character array “D26” is selected by the desired item name character array “type C” in the bottommost layer of the leftward direction search results and the desired item name character array “Water” in the bottommost layer of the upper direction search results, for example. Thus, the document processing apparatus 200 calculates as items of the weighted linear sum the degree to which the desired item name character arrays directly pointing to the non-desired item name character array match by how large the value indicating the degree to which the desired item name character arrays directly pointing to the non-desired item name character array match is and how small the edit distance is.

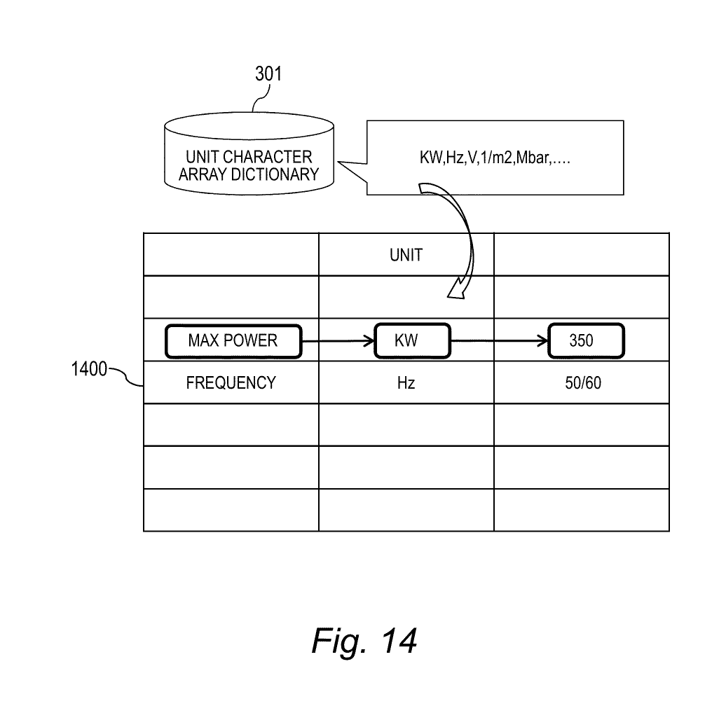

Thus, when simply looking at the degree to which the character arrays match, in the case of FIG. 12, the third hierarchy level values are “type A” and “type C,” which differ, and the fourth hierarchy level values are “Water” and “Oil,” which also differ. Also, in the case of FIG. 14, the third level values are “type B” and “temperature,” which differ, but the fourth level values are both “Water,” and thus, they match.

If the desired item name character arrays directly pointing to the non-desired item name character array are emphasized, and if there is a difference in the desired item name character array in the bottommost layer of the leftward direction search results 901 and/or the desired item name character array in the bottommost layer of the upper direction search results 902, then the document processing apparatus 200 may remove the non-desired item name character array from the non-desired item name character array linked to the hierarchized item name array.

Also, there is a high probability that the character arrays indicating units are associated with adjacent character arrays. Thus, if the non-desired item name character array indicates a unit, then the document processing apparatus 200 may add to formula (1) a correction value to lower the degree of reliability F.

FIG. 14 is a descriptive drawing showing a comparison example for when the non-desired item name character array is a unit character array. If the non-desired item name character array in a document 1400 is a unit character array, then information is added indicating this in the character array distinguishing process. Thus, if it is determined that the non-desired item name character array is a unit character array, then the document processing apparatus 200 sets a correction value to lower the degree of reliability F. The correction value to lower the degree of reliability F may be a predetermined value, or the value may be changed depending on the type of unit.

The desired item name character arrays designating units designate non-desired item name character arrays designating units. Thus, if the desired item name character array designates a unit, then the document processing apparatus 200 may add to formula (1) a correction value to lower the degree of reliability F.

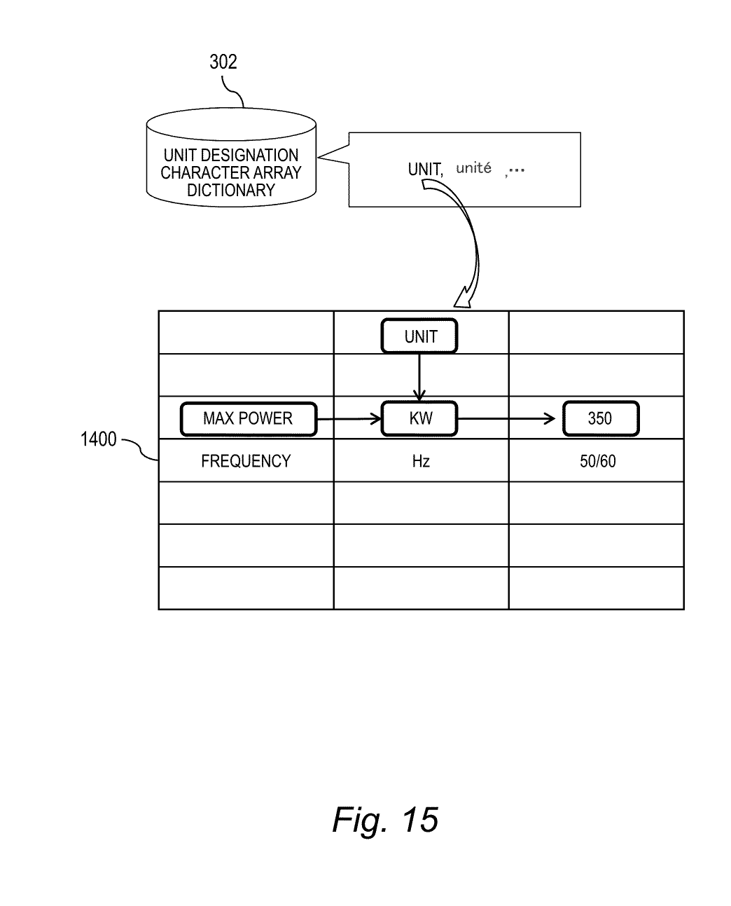

FIG. 15 is a descriptive drawing showing a comparison example for when the non-desired item name character array is a unit designation character array. If the non-desired item name character array in the document 1400 is a unit designation character array, then information is added indicating this in the character array distinguishing process. Thus, if it is determined that the non-desired item name character array is a unit designation character array, then the document processing apparatus 200 sets a correction value to lower the degree of reliability F. The correction value to lower the degree of reliability F may be a predetermined value, or the value may be changed depending on the type of unit.

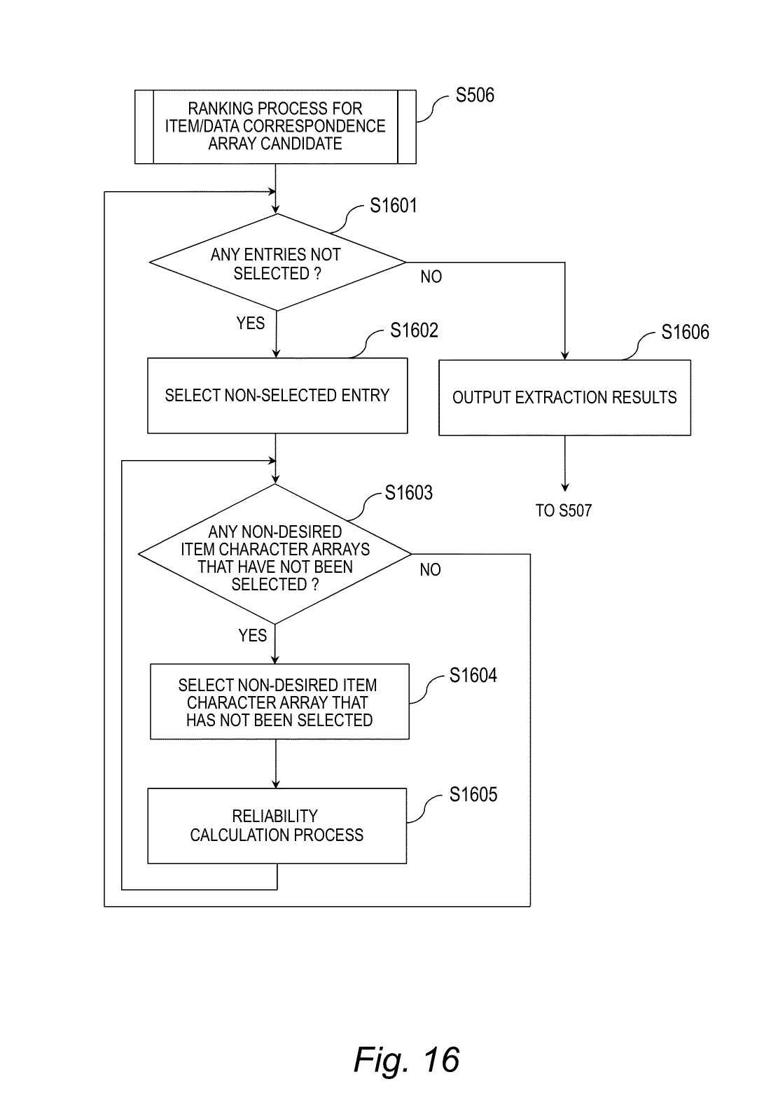

FIG. 16 is a flow chart showing an example of detailed process steps of the non-desired item name character array candidate ranking process (step S506). First, the document processing apparatus 200 determines whether or not there are any non-selected entries in the hierarchized item name dictionary 303 (step S1601). If there are non-selected entries (step S1601:Yes), then the document processing apparatus 200 selects one non-selected entry (step S1602).

Also, the document processing apparatus 200 determines whether or not there are non-desired item name character arrays that have not been selected in the selected entry (step S1603). If there are non-desired item name character arrays that have not been selected (step S1603:Yes), then the document processing apparatus 200 selects a non-selected non-desired item name character array (step S1604).

The document processing apparatus 200 uses the selected non-desired item name character array and the item/data correspondence array 910 obtained from the search results 900, and, as described above, executes a process to calculate the degree of reliability (step S1605). By the process to calculate the degree of reliability (step S1605), the degree of reliability, which indicates the plausibility of association with the hierarchized item name array, is calculated for each non-desired item name character array, which is where search was started in the search results 900. After the process to calculate the degree of reliability (step S1605), the process returns to step S1603.

In step S1603, if there are no non-desired item name character arrays that have not been selected (step S1603:No), then the process returns to step S1601. In step S1601, if there are no non-selected entries remaining (step S1601:No), then the document processing apparatus 200 outputs the extraction results 14 (step S1606). A detailed explanation of the extraction results 14 will be given later. Then, the process moves on to the ranking correction process (step S507) of FIG. 5.

<Ranking Correction Process>

In the ranking correction process (step S507), the document processing apparatus 200 corrects results of ranking according to the degree of reliability. This process is for using not only the degree of reliability according to comparison with the hierarchized item name array, but also information that does not fit the framework of the evaluation scale. Even if a unit character array is present between the item and the data, the document processing apparatus 200 ranks the correct data higher. The ranking correction process includes one in which the unit character array dictionary is used and one in which the unit designation character array is used.

In the ranking correction process using the unit character array dictionary, the document processing apparatus 200 performs a process of lowering the ranking of the item/data correspondence array candidate with a unit character array as data among the plurality of item/data correspondence arrays corresponding to each entry in the hierarchized item data dictionary. For the case shown in FIG. 14, both the character array “KW” indicating a unit and “350” are extracted as candidates. By lowering the ranking of the item/data correspondence array candidate having “KW” as data, the ranking of the item/data correspondence array candidate having “350” as data is raised.

In the ranking correction process using the unit designation character array dictionary, the document processing apparatus 200 performs a process of lowering the ranking of the item/data correspondence array candidate for which a character array included among unit designation character arrays is extracted as the item name among the plurality of item/data correspondence arrays corresponding to each entry in the hierarchized item data dictionary. For the case shown in FIG. 15, both the character array “KW” indicating a unit and “350” are extracted as candidates. By lowering the ranking of the item/data correspondence array candidate having “UNIT” as the item name, the ranking of the item/data correspondence array candidate having “350” as data is raised.

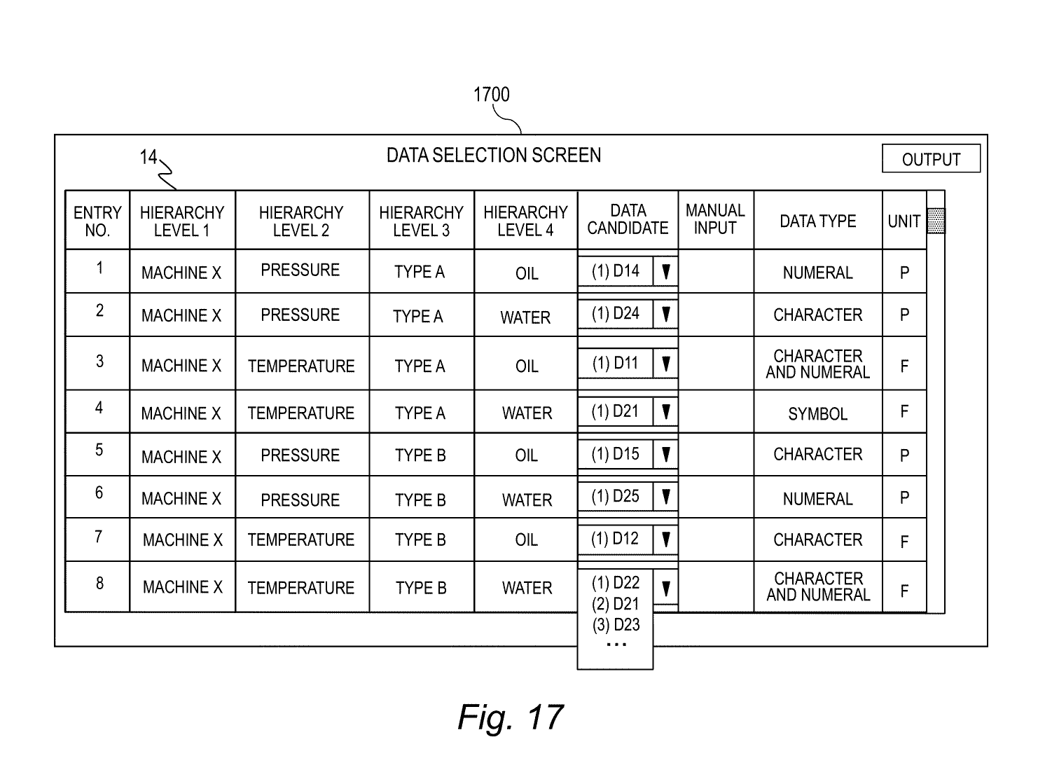

FIG. 17 is a descriptive drawing showing one example of extraction results 14 in step S1606 of FIG. 16. The extraction results 14 are displayed in the display device 203 of FIG. 2 as the data selection screen 1700. The extraction results 14 have a data candidate item, a manual input item, and a unit item for each hierarchized item name array in the hierarchized item name dictionary 303. The hierarchized desired item name character array type item and the unit item are simply taken from the hierarchized item name dictionary 303.

In the data candidate item, the non-desired item name character array candidates are displayed in a pull-down menu, for example. The non-desired item name character array candidates are displayed in order of the degree of reliability F. The document processing apparatus 200 receives input of the selection of the non-desired item name character array candidates from the pull-down menu from the input device 207. The manual input item displays information such as character arrays, numerical values, and symbols inputted from the input device 207. In this manner, if there are no desired non-desired item name character arrays among the non-desired item name character array candidates in the pull-down menu, the user can input an arbitrary value by operating the input device 207. Selection from the pull-down menu and manual input operation constitute the ranking correction process (step S507) shown in FIG. 5.

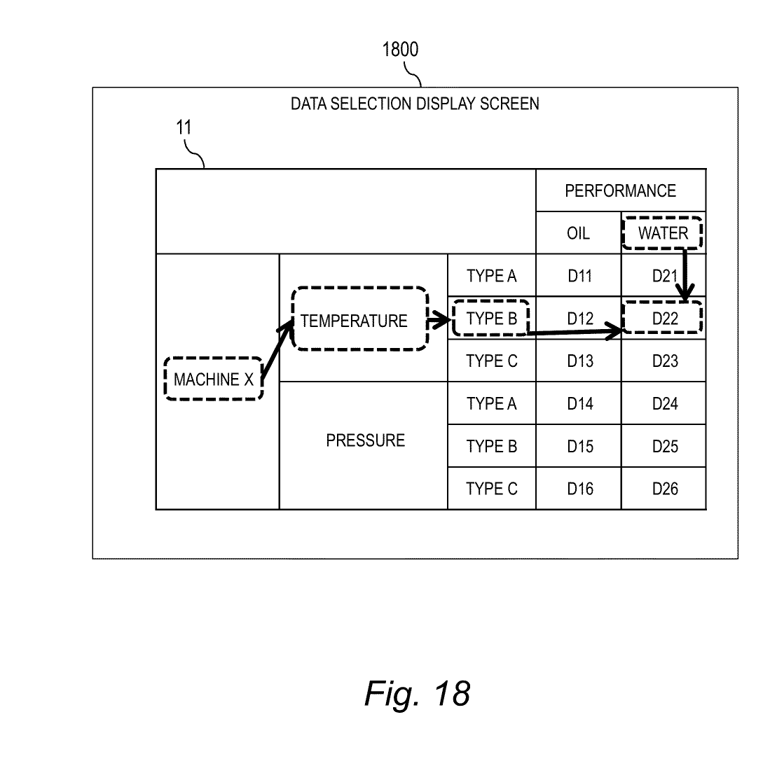

FIG. 18 is a descriptive drawing showing a data selection display screen example 1. The data selection display screen 1800 displays the obtained document 11. The respective frames of the displayed document 11 are associated with nodes in the network for multiple hypothetical document structures 12. If a non-desired item name character array candidate is selected in FIG. 18, then the document processing apparatus 200 reads from the memory 205 or the auxiliary storage device 206 the search results 900 for the selected non-desired item name character array candidate, and displays it over the document 11 on the data selection display screen 1800. If, for example, in FIG. 17, the user selects the non-desired item name character array candidate “D22” having the highest degree of reliability in the entry e8 of the data selection screen 1700, the document processing apparatus 200 identifies search results for the non-desired item name character array “D22” in FIG. 18 by associating dotted rectangles and arrows with the search results.

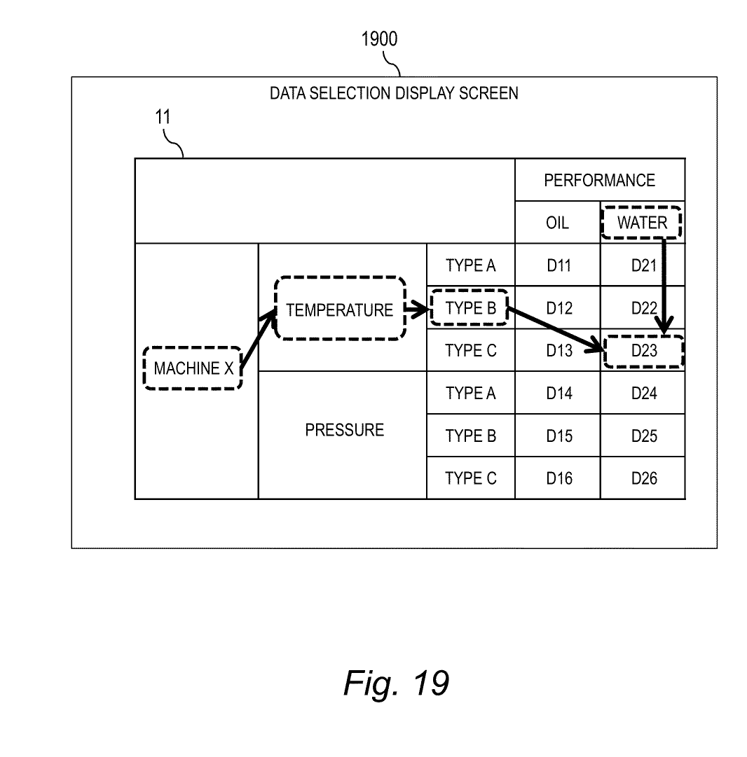

FIG. 19 is a descriptive drawing showing a data selection display screen example 2. A case was described in which, in FIG. 18, the non-desired item name character array candidate “D22” having the highest degree of reliability was selected by the user in the entry e8 of the data selection screen 1700 in FIG. 17. In FIG. 19 is an example of a data selection display screen 1900 in which the non-desired item name character array candidate “D23” having the third highest degree of reliability was selected by the user in the entry e8 of the data selection screen of FIG. 17.

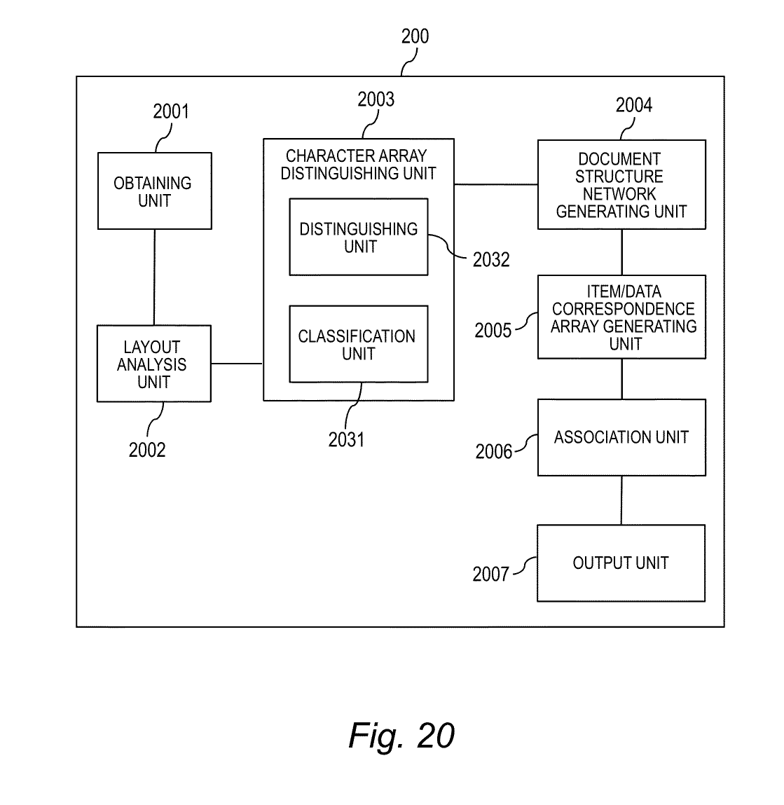

In this case, the non-desired item name character array to be selected by the desired item name character array “type B” and the desired item name character array “Water” should be “D22,” but is instead “D23” in FIG. 20. Thus, it can visually seen that “D23” is not the appropriate choice to associate with “machine X->temperature->type B->Water.”

<Mechanical Configuration Example of Document Processing Apparatus 200>

FIG. 20 is a block diagram showing a mechanical configuration example of the document processing apparatus 200. The document processing apparatus 200 has an acquisition unit 2001, a layout analysis unit 2002, a character array distinguishing unit 2003, a document structure network generating unit 2004, an item/data correspondence array generating unit 2005, an association unit 2006, and an output unit 2007. The configurations 2001 to 2007 realize their respective functions by executing in the processor programs stored in the memory 205 or the auxiliary storage device 206 shown in FIG. 2, for example.

The acquisition unit 2201 obtains the document 11. Specifically, the acquisition unit 2001 executes the document acquisition process (step S501) of FIG. 5, for example. The layout analysis unit 2002 analyzes the layout of the document 11 acquired by the acquisition unit 2001. Specifically, the layout acquisition unit 2002 executes the layout acquisition process (step S502) of FIG. 5, for example.

The character array distinguishing unit 2003 distinguishes character arrays in the document 11. Specifically, the character array distinguishing unit 2003 executes the character array distinguishing process (step S503) of FIG. 5, for example. The character array distinguishing unit 2003 has a classification unit 2031 and a distinguishing unit 2032. The classification unit 2031 classifies the character arrays into desired item name character arrays, which correspond to item names included among dictionary information stored in the hierarchized item name array in which the item names are hierarchized, and non-desired item name character arrays, which do not correspond to the item names.

The dictionary information storing the hierarchized item name arrays in which the item names are hierarchized is the hierarchized item name dictionary 303 shown in FIG. 4. The classification unit 2031 executes match determination between the item names in the hierarchized item name dictionary 303 and a group of character arrays in a document in the character array distinguishing process (step S503) shown in FIG. 5, thereby classifying the group of character arrays in the document into desired item name character arrays and non-desired item name character arrays. The determination unit 2032 executes the determination of the type of characters, determination of whether or not there is a match with unit character arrays, or determination of whether or not there is a match with unit designation character arrays in the character array distinguishing process (step S503) shown in FIG. 5.

The document structure network generating unit 2004 links a certain character array to a character array to the right thereof from the certain character array in the document or a region including the certain character array towards the right and below. Also, the document structure network generating unit 2004 links a certain character array to a character array located therebelow. In this manner, the document structure network generating unit 2004 generates a network for multiple hypothetical document structures. The region including the certain character array is a frame including this character array, for example. Specifically, the document structure network generating unit 2004 executes a process to generate a network for multiple hypothetical document structures (step S504) shown in FIG. 5.

The item/data correspondence array generating unit 2005 searches for a desired item name character array leftward and upward from a non-desired item name character array in the network for multiple hypothetical document structures 12. The item/data correspondence array generating unit 2005 generates an item/data correspondence array by linking the leftward direction search results and the upper direction search results. Specifically, the item/data correspondence array generating unit 2005 executes an item/data correspondence array generating process (step S505) shown in FIG. 5.

The association unit 2006 associates the hierarchized item name array with the non-desired item name character array, which is the source of the item/data correspondence array, according to the degree of reliability indicating the relatedness of the hierarchized item name array and the item/data correspondence array. Specifically, the association unit 2006 executes a desired item name character array candidate ranking process (step S506) shown in FIG. 5, for example. In other words, the association unit 2006 calculates the degree of reliability F and associates the non-desired item named character arrays with the respective hierarchized item name arrays in order of degree of reliability F.

The output unit 2007 outputs the associated hierarchized item name arrays and non-desired item name character arrays. Specifically, it outputs the screens shown in FIGS. 17 to 19, for example. According to the embodiment above, it is possible to improve accuracy of data extraction from the document 11 without defining the network structure of the document 11 in advance.

Also, in the embodiment above, there are frames in the inputted document, but it is possible to use a document that does not have frames or a document in which some of the ruled lines constituting the frames are missing. Below, a case in which data extraction is performed in a document with no frames will be described.

If there are no frames, the document processing apparatus 200 generates a network for multiple hypothetical document structures by using array analysis results of the character array position instead of an array analysis of the frame position. Layout analysis for a case in which there are no frames includes a top-down analysis method such as XY cut, a bottom-up analysis method in which the distance between character rectangles is determined and the character rectangles are combined, a method in which the top-down analysis method is combined with the bottom-up analysis method, and the like. Analysis results differ depending on the analysis method or parameters.

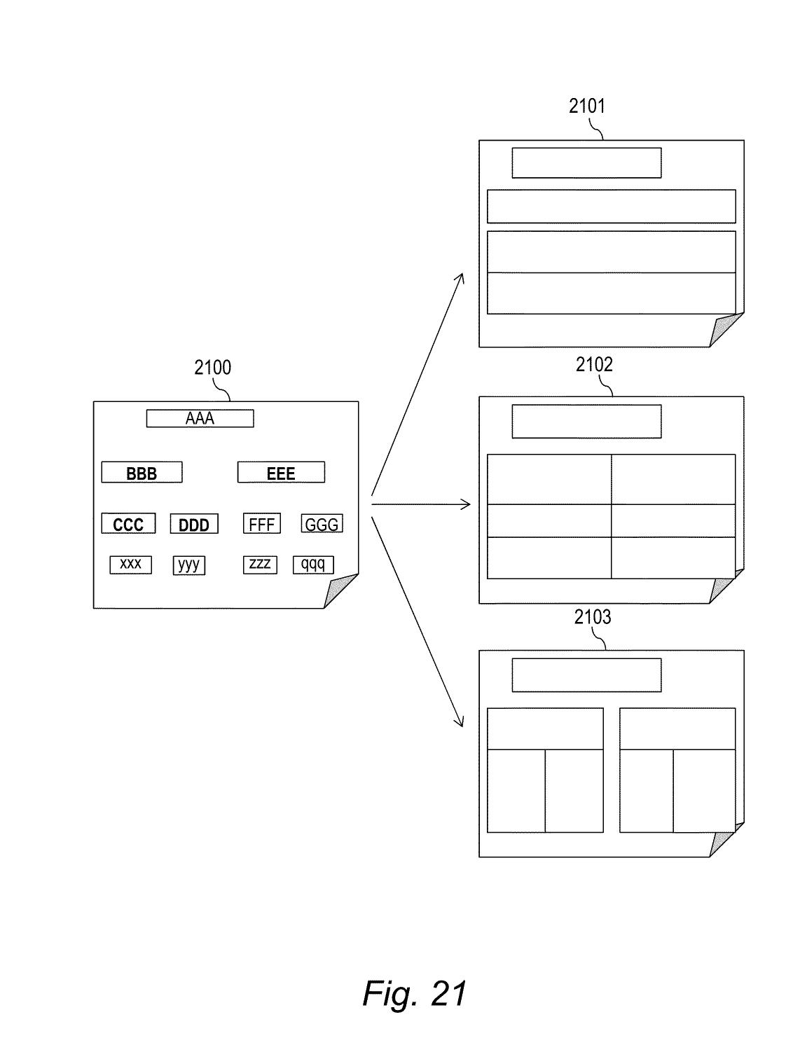

FIG. 21 shows three different types of layout analysis results for an inputted document. In the layout analysis results 2101, the rectangles are combined primarily in the row direction (horizontal direction). In the layout analysis results 2102, separation is performed not only in the row direction but also in the column direction (vertical direction). The layout analysis results C are results in which separation is prioritized in the vertical direction compared to the method of the layout analysis results B. Character arrays in each block in each of the layout analysis results have a linking relationship.

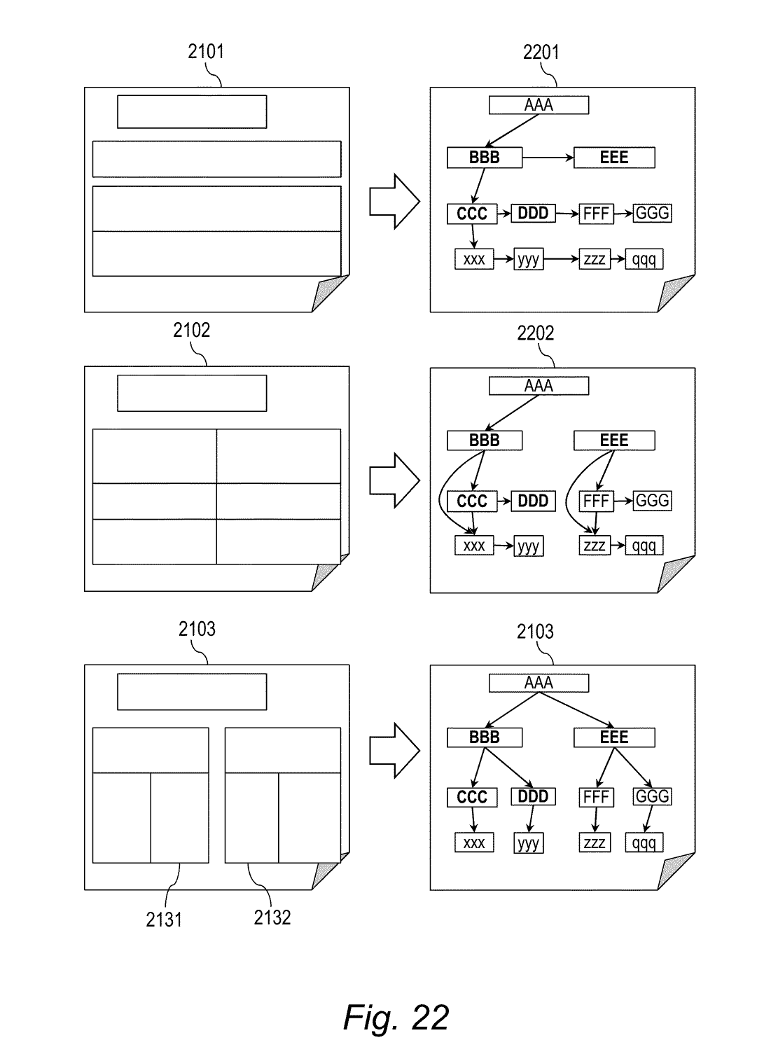

The document structure networks 2201 to 2203 of FIG. 22 show logical structures of the layout analysis results 2101 to 2103. Specifically, in the document structure network 2201, the character arrays from the character array BBB to the character array EEE in the same block are linked. Similarly, the character array CCC to the character array DDD, the character array DDD to the character array FFF, the character array FFF to the character array GGG, the character array xxx to the character array yyy, the character array yyy to the character array zzz, and the character array zzz to the character array qqq are respectively linked. Also, because these are links between blocks, the head character arrays are linked from top to bottom.

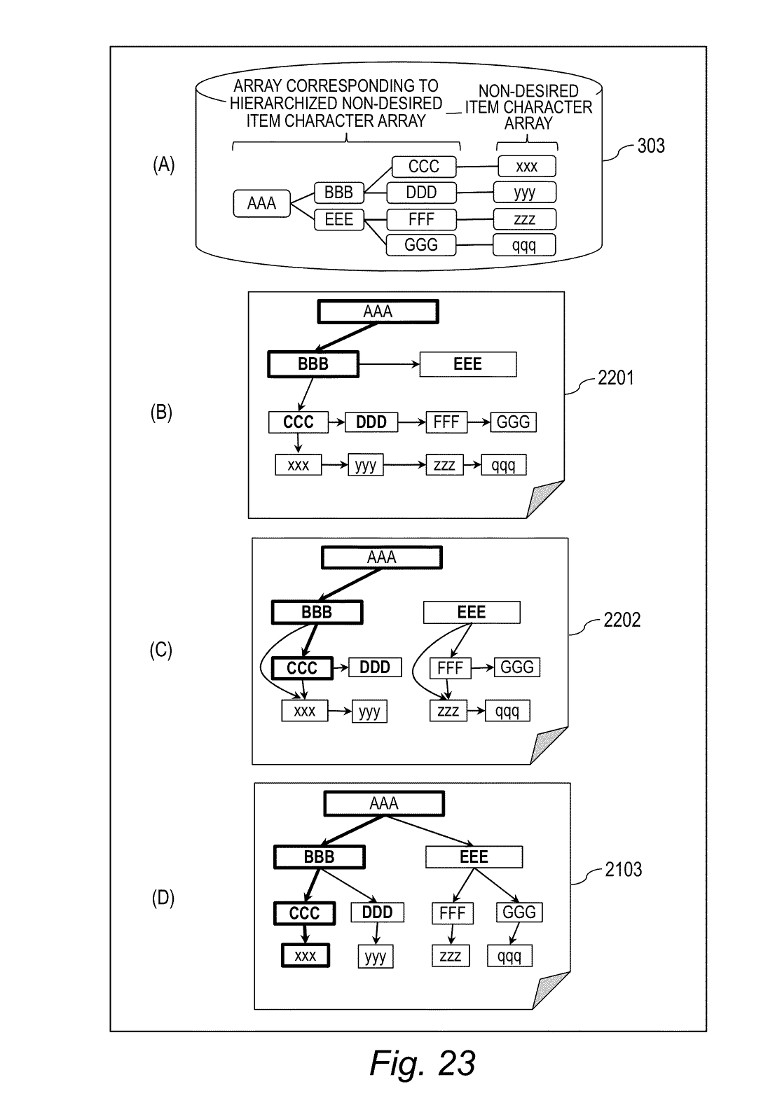

FIG. 23 is a descriptive drawing showing search results. (A) shows a hierarchized item name dictionary 303. (A) schematically expresses the hierarchized item name array as a tree structure. In the document structure network 2201, it is only possible to trace the path from the character array AAA to the character array BBB. In the network for multiple hypothetical document structures 2103, it is possible to traverse the path of (B) the character array AAA to the character array BBB, (C) the character array BBB to the character array CCC, and (D) the character array CCC to the character array XXX. As a result, an item/data correspondence array with the character array AAA, the character array BBB, and the character array CCC as item names and the character array xxx as data is generated.

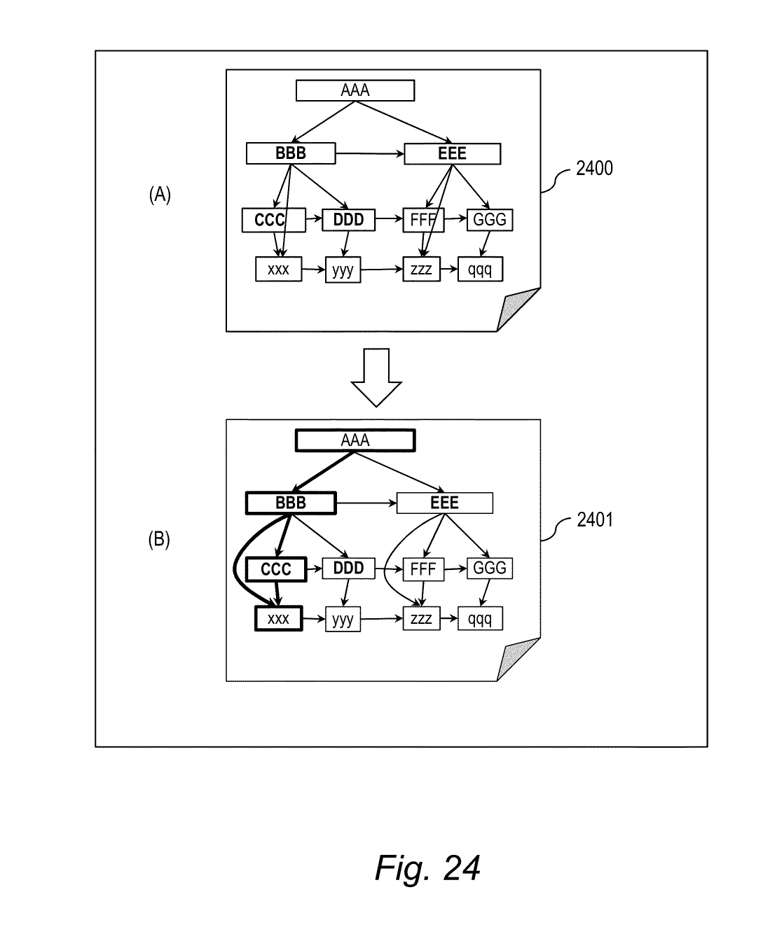

FIG. 24 is a descriptive drawing showing an example of layout analysis results being combined. The document processing apparatus 200 performs a logical disjunction on the networks for multiple hypothetical document structures 2201 to 2203. (A) is the network for multiple hypothetical document structures 2400, formed by the logical disjunction of the networks for multiple hypothetical document structures 2201 to 2203. Performing a logical disjunction enables generation of one network that covers the original networks for multiple hypothetical document structures.

(B) shows a search example of a network for multiple hypothetical document structures 2400 for a case in which the non-desired item name character array “xxx” is selected. The bold line is the search path and the bold frame nodes are searched nodes. The document processing apparatus 200 may execute separate searches respectively for the networks for multiple hypothetical document structures 2201 to 2203 as shown in FIG. 23, or combine the networks into the network for multiple hypothetical document structures 2400 and then perform a search as in FIG. 24.

As described above, the method of the embodiment above enables improvement in the accuracy of data extraction from the document without defining the network structure of the document in advance. Also, the document processing apparatus 200 calculates the degree of reliability F indicating the degree of similarity between the hierarchized item name array and the item/data correspondence array according to the degree to which the hierarchized item name array of the hierarchized item name dictionary matches the item/data correspondence array, and then associates the hierarchized item name array with the non-desired item name character array according to the value of the degree of reliability F. In this manner, the document processing apparatus can associate a plausible non-desired item name character array with the hierarchized item name array even if it is unknown what type of network structure the inputted document has. The degree of reliability is calculated for each non-desired item name character array, and thus, associating the respective non-desired item name character arrays in the order of degree of reliability F enables the user to confirm with ease which non-desired item name character array is plausible.

Also, by selecting a ranked item/data correspondence array, the non-desired item name character array and the desired item name of the selected item/data correspondence array is displayed on the document. Thus, the user can intuitively see which combination of item names points to the non-desired item name character array from the row direction and the column direction.

Also, by taking into consideration the order of item names in the hierarchized item name array and the order of item names in the item/data correspondence array when determining the degree of reliability F, this causes the degree of reliability F to increase the more correct the hierarchical order is. This improves extraction accuracy of the non-desired item name character array to be associated. Also, even if the order differs in part, as long as a portion thereof matches, this is taken into consideration when determining the degree of reliability. Thus, the degree of reliability is higher for item/data correspondence arrays where the item name order is the same, and the document processing apparatus can rank the correct item/data correspondence array at the top.

Also, the item name at the bottommost layer in the row direction and the item name at the bottommost layer in the column direction directly point to the non-desired item name character array. Thus, by correcting the degree of reliability F upward if these item names match the item name at the bottommost layer of the hierarchized item name array, it is possible to improve the accuracy of extraction of data to be associated. This is because, among the item names recorded in each entry, the higher order item names are often terms modifying the lower order item names, and the item names in bottommost layer are often terms directly pointing to data.

In this manner, the document processing apparatus of the present embodiment can extract data at high accuracy even froth a document having a plurality of item names with the items pointing to data having a hierarchical structure, or a document with complex and various structures such as character arrays indicating units being included between items and data, and no frame borders being present.

Also, the document processing apparatus can extract data corresponding to a specification item having a hierarchical structure merely by designating a hierarchized item data dictionary. Thus, even a user with no specialist knowledge pertaining to document recognition techniques can define and use a dictionary. Also, there is no need to define in a dictionary information relating to all item names in a specification document, and the user only needs to create a dictionary of desired item names. Thus, the document processing apparatus can be applied to the extraction of data from documents having various specification items.

A specification data extraction tool that can perform a recognition operation, a correction operation, and a recording operation on data extracted by the above method extracts a plurality of pieces of possible data as candidates and has an interface providing these to the user. Thus, it is possible to find correct data from other data candidates even if there were a mistake in the first data candidate. Thus, there are many formats that can be used and the method can be used even if it is not possible to ensure high recognition accuracy.

In this manner, the document processing apparatus of the present invention can express various document structures without the need to define in advance the relative positional relations between items for each document format and only with the use of a hierarchized item name dictionary relating to items indicating desired data, and thus, with little cost associated with definition in advance. The hierarchized item name dictionary enables the extraction of data from documents of various formats at a high accuracy and can allow for application on a wider range of documents. This invention has been described in detail so far with reference to the accompanying drawings, but this invention is not limited to those specific configurations described above, and includes various changes and equivalent components within the gist of the scope of claims appended.

What is claimed is:

1. A document processing method executed by a computer having a processor that executes programs, and a memory that stores the programs to be executed by the processor,
wherein the processor links a certain character array in a group of character arrays in a document with a character array located in a rightward direction thereof from the certain character array or a region including the certain character array towards the rightward direction and a downward direction, and links the certain character array to a character array located therebelow, thereby generating a network for multiple hypothetical document structures.

2. The document processing method according to claim 1,
wherein the processor executes:
a classification process of classifying the group of character arrays into desired item name character arrays corresponding to item names included among dictionary information stored in the hierarchized item name array, in which the item names in a table are hierarchized, and non-desired item name character arrays not corresponding to said item names;
a generation process of generating an item/data correspondence array in the generated network for multiple hypothetical document structures in which the desired item name character array is searched in a leftward direction towards a higher hierarchy level from the non-desired item name character array classified in the classification process and the desired item name character array is searched upward towards the higher hierarchy level, thereby generating the item/data correspondence array where search results in the leftward direction and search results in the upward direction are linked;
an association process of associating the hierarchized item name array with the item/data correspondence array generated in the generation process according to a degree of reliability indicating the degree of relatedness between the hierarchized item name array and the item/data correspondence array; and
an output process of outputting the hierarchized item name array and the item/data correspondence array associated in the association process, and the non-desired item name character array in the item/data correspondence array.

3. The document processing method according to claim 2,
wherein the processor executes in the association process:
calculating the degree of reliability on the basis of a degree to which the item name of the hierarchized item name array matches the desired item name character array in the item/data correspondence array, and associating the hierarchized item name array with the non-desired item name character array that is an origin of the item/data correspondence array according to the calculated degree of reliability.

4. The document processing method according to claim 3,
wherein the processor additionally executes in the association process:
calculating the degree of reliability on the basis of an array of the item names in the hierarchized item name array and an array of the desired item name character array in the item/data correspondence array, and associating the hierarchized item name array with the non-desired item name character array that is an origin of the item/data correspondence array according to the calculated degree of reliability.

5. The document processing method according to claim 3,
wherein the processor additionally executes in the association process:
calculating the degree of reliability on the basis of the degree to which an item name in a bottommost layer in the leftward direction and an item name in a bottommost layer in the downward direction of the hierarchized item name array matches the desired item name character array in a bottommost layer in the leftward direction of the item/data correspondence array and the desired item name character array in a bottommost layer of the item/data correspondence array in the downward direction, and associating the hierarchized item name array with the non-desired item name character array that is an origin of the item/data correspondence array according to the calculated degree of reliability.

6. The document processing method according to claim 3,
wherein the dictionary information further includes a unit character array indicating a unit,
wherein the processor executes a distinguishing process of distinguishing whether or not the non-desired item name character array corresponds to the unit character array with reference to the dictionary information, and
wherein the processor additionally executes in the association process:
calculating the degree of reliability on the basis of distinguishing results obtained by the distinguishing process, and associating the hierarchized item name array with the non-desired item name character array that is an origin of the item/data correspondence array according to the calculated degree of reliability.

7. The document processing method according to claim 3,
wherein the dictionary information further includes a unit designation character array that is an item name designating a unit,
wherein the processor executes a distinguishing process of distinguishing whether or not at least one of an item name in a bottommost layer in the rightward direction and an item in a bottommost layer in the downward direction of the hierarchized item name array corresponds to the unit designation character array, with reference to the dictionary information, and
wherein the processor additionally executes in the association process:
calculating the degree of reliability on the basis of distinguishing results obtained by the distinguishing process, and associating the hierarchized item name array with the non-desired item name character array that is an origin of the item/data correspondence array according to the calculated degree of reliability.

8. The document processing method according to claim 3, wherein the processor executes in the output process:
outputting a screen displaying the non-desired item name character arrays associated with the hierarchized item name array in order according to the degree of reliability.

9. The document processing method according to claim 8, wherein the processor executes in the output process:
outputting, if any of the non-desired item name character arrays is selected on the screen displaying the non-desired item name character arrays in order according to the degree of reliability, a screen displaying search results in the leftward direction and search results in the downward direction of the selected non-desired item name character array so as to be superimposed over the document.

10. A document processing apparatus having a processor that executes programs, and a memory that stores the programs to be executed by the processor,
wherein the processor links a certain character array in a document with a character array located in a rightward direction thereof from the certain character array or a region including the certain character array towards the rightward direction and a downward direction, and links the certain character array to a character array located therebelow, thereby generating a network for multiple hypothetical document structures.

11. A document processing program, causing a computer, having a processor that executes programs and a memory that stores the programs to be executed by the processor, to link a certain character array in a document with a character array located in a rightward direction thereof from the certain character array or a region including the certain character array towards the rightward direction and a downward direction, and to link the certain character array to a character array located therebelow, thereby generating a network for multiple hypothetical document structures.
